(19) United States
(12) Patent Application Publication
(10) Pub. No.: US 2025/0300318 A1
(43) Pub. Date: Sep. 25, 2025

(54) BATTERY

(71) Applicant: Panasonic Intellectual Property Management Co., Ltd., Osaka (JP)

(72) Inventor: EIICHI KOGA, Hokkaido (JP)

(21) Appl. No.: 19/231,401

(22) Filed: Jun. 6, 2025

Related U.S. Application Data
(63) Continuation of application No. PCT/JP2023/028496, filed on Aug. 4, 2023.

(30) Foreign Application Priority Data
Dec. 27, 2022 (JP) 2022-210809

(51) Int. Cl. H01M 50/46; H01M 10/0585; H01M 50/449; H01M 50/533

(52) U.S. Cl. CPC H01M 50/46; H01M 10/0585; H01M 50/449; H01M 50/533

(57) ABSTRACT

A battery according to the present disclosure includes: a plurality of unit cells each including a pair of electrode layers whose polarities differ from each other, and a solid electrolyte layer that is positioned between the pair of electrode layers; and a plurality of current collectors. The battery has a structure such that the plurality of unit cells and the plurality of current collectors are laminated. The plurality of current collectors include a first current collector that is positioned between the plurality of unit cells and a second current collector that is positioned at a surface portion in a laminating direction of the structure. An end portion of the first current collector is thicker than a central portion of the first current collector. At least a part of the first current collector is thicker than the second current collector.

### BACKGROUND

### 1. Technical Field

The present disclosure relates to a battery.

### 2. Description of the Related Art

Japanese Unexamined Patent Application Publication No. 8-78025 discloses a laminated battery in which unit cells are laminated and connected in series. Japanese Unexamined Patent Application Publication No. 2008-123955 discloses a serially-connected laminated battery including a bipolar electrode in which a positive electrode layer and a negative electrode layer are formed on the front and back surfaces of a current collector.

### SUMMARY

In the related art, there is a demand for a battery having high reliability.

In one general aspect, the techniques disclosed here feature a battery including: a plurality of unit cells each including a pair of electrode layers whose polarities differ from each other, and a solid electrolyte layer that is positioned between the pair of electrode layers; and a plurality of current collectors. The battery has a structure such that the plurality of unit cells and the plurality of current collectors are laminated. The plurality of current collectors include a first current collector that is positioned between the plurality of unit cells and a second current collector that is positioned at a surface portion in a laminating direction of the structure such that the plurality of unit cells and the plurality of current collectors are laminated. An end portion of the first current collector is thicker than a central portion of the first current collector. At least a part of the first current collector is thicker than the second current collector.

With the present disclosure, it is possible to provide a battery having high reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a sectional view of a battery according to an embodiment;

FIG. 1B is a plan view of the battery according to the embodiment;

FIG. 1C is a side view illustrating an example of the planar shape of an inner covering according to the embodiment;

FIG. 1D is a side view illustrating an example of the planar shape of the inner covering according to the embodiment;

FIG. 1E is a side view illustrating an example of the planar shape of the inner covering according to the embodiment;

FIG. 1F is an enlarged sectional view illustrating a state in which a gap is formed between a unit cell and a current collector according to the embodiment;

FIG. 2A is a sectional view of a battery according to a first modification of the embodiment;

FIG. 2B is a plan view of the battery according to the first modification of the embodiment;

FIG. 3A is a sectional view of a battery according to a second modification of the embodiment;

FIG. 3B is a plan view of the battery according to the second modification of the embodiment;

FIG. 4A is a sectional view of a battery according to a third modification of the embodiment;

FIG. 4B is a plan view of the battery according to the third modification of the embodiment;

FIG. 5A is a sectional view of a battery according to a fourth modification of the embodiment;

FIG. 5B is a plan view of the battery according to the fourth modification of the embodiment;

FIG. 6A is a sectional view of a battery according to a fifth modification of the embodiment;

FIG. 6B is a plan view of the battery according to the fifth modification of the embodiment;

FIG. 7A is a sectional view of a battery according to a sixth modification of the embodiment;

FIG. 7B is a plan view of the battery according to the sixth modification of the embodiment;

FIG. 8A is a sectional view of a battery according to a seventh modification of the embodiment;

FIG. 8B is a plan view of the battery according to the seventh modification of the embodiment;

FIG. 8C is a plan view illustrating an example of the arrangement of a plurality of third coverings according to the seventh modification of the embodiment;

FIG. 8D is a partial sectional view illustrating a third covering that is completely embedded in a side surface according to the seventh modification of the embodiment;

FIG. 8E is a partial sectional view illustrating the size of a third covering according to the seventh modification of the embodiment;

FIG. 8F is a partial sectional view illustrating the size of another third covering according to the seventh modification of the embodiment;

FIG. 9A is a sectional view of a battery according to an eighth modification of the embodiment;

FIG. 9B is a plan view of the battery according to the eighth modification of the embodiment;

FIG. 10A is a sectional view of a battery according to a ninth modification of the embodiment;

FIG. 10B is a plan view of the battery according to the ninth modification of the embodiment;

FIG. 11A is a sectional view of a battery according to a tenth modification of the embodiment; and

FIG. 11B is a plan view of the battery according to the tenth modification of the embodiment.

### DETAILED DESCRIPTIONS

### Overview of Present Disclosure

Hereafter, as an overview of the present disclosure, examples of a battery according to the present disclosure will be described.

A battery according to a first aspect of the present disclosure includes: a plurality of unit cells each including a pair of electrode layers whose polarities differ from each other, and a solid electrolyte layer that is positioned between the pair of electrode layers; and a plurality of current collectors. The battery has a structure such that the plurality of unit cells and the plurality of current collectors are laminated. The plurality of current collectors include a first current collector that is positioned between the plurality of unit cells and a second current collector that is positioned at a surface portion in a laminating direction of the structure such that the plurality of unit cells and the plurality of current collectors are laminated. An end portion of the first current collector is thicker than a central portion of the first current collector. At least a part of the first current collector is thicker than the second current collector.

Regarding a battery in which a plurality of unit cells are laminated, since the layers of the plurality of unit cells are present above and below a central portion of the battery, heat is not easily dissipated from the central portion and the central portion tends to have a high temperature. With the configuration of the present aspect, at least a part of the first current collector, which is sandwiched between the unit cells, is thicker than the second current collector, which is positioned at a surface portion. Moreover, an end portion of the first current collector, from which heat is dissipated to the outside, is thicker than a central portion of the first current collector. Therefore, heat is easily dissipated from the first current collector to the outside of the battery. Therefore, dissipation of heat from the central portion of the battery, where the operation temperature is high and characteristic deterioration tends to occur, is promoted by the first current collector, and it is possible to realize a battery having high reliability.

For example, according to a second aspect of the present disclosure, the battery according to the first aspect may further include a first covering that is continuous with the end portion of the first current collector, that extends from the end portion along a side surface of a first unit cell, among the plurality of unit cells, adjacent to the first current collector, and that covers a part of the side surface of the first unit cell. The first covering and the first current collector are integrally formed.

In this case, since the first covering, which is integrated with the first current collector, extends while covering the side surface of the first unit cell, dissipation of heat from a central portion of the battery is further promoted, and it is possible to realize a battery having higher reliability. Moreover, since the first covering binds the side surface of the first unit cell, it is possible to remedy a problem in that lamination tends to occur at the interface between a current collector and an electrode layer due to repetition of expansion and contraction of the electrode layer caused by charging and discharging.

For example, according to a third aspect of the present disclosure, the battery according to the second aspect may further include a second covering that is continuous with an end portion of the second current collector, that extends from the end portion along a side surface of a second unit cell, among the plurality of unit cells, adjacent to the second current collector, and that covers a part of the side surface of the second unit cell. The second covering and the second current collector are integrally formed. A length of the first covering in an extension direction is larger than a length of the second covering in an extension direction.

In this case, dissipation of heat of a surface portion of the battery is promoted by the second covering, dissipation of heat from a central portion of the battery is further promoted by the first covering, which is larger than the second covering, and it is possible to realize a battery having high reliability.

For example, according to a fourth aspect of the present disclosure, in the battery according to the second or third aspect, the first covering may cover a part of a side surface of an electrode layer, among the pair of electrode layers of the first unit cell, adjacent to the first current collector.

In this case, since the first covering directly dissipates heat from an electrode layer that tends to generate heat, the heat dissipation performance is further increased. Thus, it is possible to realize a battery having high reliability.

For example, according to a fifth aspect of the present disclosure, in the battery according to any one of the second to fourth aspects, at least a part of the first covering may be embedded in the side surface of the first unit cell.

In this case, the bondability between the first covering and the side surface of the first unit cell is improved, and the thermal shock resistance and the bending resistance of the first covering are improved. Thus, it is possible to further increase the reliability of the battery.

For example, according to a sixth aspect of the present disclosure, in the battery according to the fifth aspect, the first covering need not protrude beyond the side surface of the first unit cell.

In this case, the first covering is completely embedded in the side surface of the first unit cell, and the bondability between the first covering and the side surface of the first unit cell is further improved.

For example, according to a seventh aspect of the present disclosure, in the battery according to any one of the second to sixth aspects, the first covering may cover a part of the side surface of the first unit cell from one end to the other end of the side surface in a direction perpendicular to the laminating direction, and a length of the first covering in an extension direction may be larger in both end portions of the first covering in the direction perpendicular to the laminating direction than in a central portion of the first covering in the direction perpendicular to the laminating direction.

In this case, the first covering more strongly binds end regions of the side surface of the first unit cell, which tend to become the starting point of interlayer delamination due to repeated charging and discharging and thermal cycle, and therefore interlayer delamination can be suppressed. Thus, it is possible to realize a battery having high reliability.

For example, according to an eighth aspect of the present disclosure, in the battery according to any one of the second to sixth aspects, the first covering may cover a part of the side surface of the first unit cell from one end to the other end of the side surface in a direction perpendicular to the laminating direction, and a length of the first covering in an extension direction may be larger in a central portion of the first covering in the direction perpendicular to the laminating direction than in both end portions of the first covering in the direction perpendicular to the laminating direction.

In this case, the first covering more strongly binds the central portion of the first unit cell, where interlayer delamination tends to occur due to the effect of a bending stress on the battery, and therefore interlayer delamination at the central portion of the first unit cell can be suppressed. Thus, it is possible to realize a battery having high reliability.

For example, according to a ninth aspect of the present disclosure, in the battery according to any one of the second to eighth aspects, the first covering may cover a corner of the first unit cell including an edge of the side surface of the first unit cell in a direction perpendicular to the laminating direction.

In this case, the first covering binds the corner of the first unit cell, which particularly tends to become the starting point of interlayer delamination due to repeated charging and discharging and thermal cycle, and therefore interlayer delamination can be further suppressed. Moreover, since the first covering protects the corner of the first unit cell, which is fragile, impact resistance is also improved. Thus, it is possible to realize a battery having high reliability.

For example, according to a tenth aspect of the present disclosure, in the battery according to any one of the second to ninth aspects, at least a part of the first covering may have lower crystallinity than the first current collector.

In this case, the plastic deformability of the first covering is increased due to decrease of crystallinity caused by increase of lattice defects such as dislocation or the like, and the first covering can be closely bonded to so as to follow small protrusions and recesses of the side surface of the first unit cell. Therefore, the performance of heat dissipation from the first unit cell improves as the bonding area between the first covering and the side surface of the first unit cell increases. Moreover, the bondability between the first covering and the side surface of the first unit cell is increased. Thus, it is possible to realize a battery having high reliability.

For example, according to an eleventh aspect of the present disclosure, in the battery according to any one of the second to tenth aspects, a portion of the first covering adjacent to the side surface of the first unit cell may have higher crystallinity than a portion of the first covering opposite from the side surface of the first unit cell.

In this case, the portion of the first covering adjacent to the side surface of the first unit cell has high thermal conductivity, and heat can be transferred to the surface of the first covering with a small loss. Thus, the performance of heat dissipation from the first unit cell through the first covering is improved, and it is possible to further promote dissipation of heat from a central portion of the battery. Thus, it is possible to realize a battery having higher reliability.

For example, according to a twelfth aspect of the present disclosure, in the battery according to any one of the second to eleventh aspects, a distal end portion of the first covering in an extension direction may have lower crystallinity than a portion of the first covering continuous with the first current collector.

In this case, it is possible to cause the end portion of the first covering, which tends to peel off from the side surface of the first unit cell, to be in contact with the side surface of the first unit cell in a state in which the end portion is soft, the end portion of the first covering absorbs a stress of expansion and contraction of the electrode layer due to charging and discharging operations and thermal expansion difference, and the first covering and the side surface of the first unit cell can be more strongly bonded. Thus, it is possible to realize a battery having high reliability.

For example, according to a thirteenth aspect of the present disclosure, in the battery according to any one of the first to twelfth aspects, at least a part of the first current collector may have higher crystallinity than the second current collector.

In this case, the first current collector near a central portion of the battery has high thermal conductivity, and it is possible to further promote dissipation of heat of the central portion of the battery. Thus, it is possible to realize a battery having high reliability.

For example, according to a fourteenth aspect of the present disclosure, the battery according to any one of the first to thirteenth aspects may further include: a first covering that is continuous with the end portion of the first current collector, that extends from the end portion along a side surface of a first unit cell, among the plurality of unit cells, adjacent to the first current collector, and that covers a part of the side surface of the first unit cell; and a second covering that is continuous with an end portion of the second current collector, that extends from the end portion along a side surface of a second unit cell, among the plurality of unit cells, adjacent to the second current collector. and that covers a part of the side surface of the second unit cell. The first covering and the first current collector are integrally formed. The second covering and the second current collector are integrally formed. At least a part of the first covering has higher crystallinity than the second covering.

In this case, the first covering continuous with the first current collector near the central portion of the battery has high thermal conductivity, and therefore it is possible to further promote dissipation of heat of the central portion of the battery. Thus, it is possible to realize a battery having high reliability.

For example, according to a fifteenth aspect of the present disclosure, the battery according to any one of the first to fourteenth aspects may further include at least one third covering that covers a part of a side surface of at least one unit cell among the plurality of unit cells, that is isolated on the side surface of the at least one unit cell, and that is electroconductive.

In this case, the third covering, which is isolated on the side surface of the unit cell, can promote heat dissipation of the battery without affecting the battery characteristics. Thus, it is possible to realize a battery having higher reliability.

For example, according to a sixteenth aspect of the present disclosure, in the battery according to the fifteenth aspect, the at least one third covering may include a third covering at least a part of which is embedded in the side surface of the at least one unit cell.

In this case, the bondability between the third covering and the side surface of the unit cell is improved, and the thermal shock resistance and the bending resistance of the third covering is improved. Thus, it is possible to further increase the reliability.

For example, according to a seventeenth aspect of the present disclosure, in the battery according to the sixteenth aspect, the third covering at least a part of which is embedded in the side surface of the at least one unit cell need not protrude beyond the side surface of the at least one unit cell.

In this case, the third covering is completely embedded in the side surface of the unit cell, and the bondability between the third covering and the side surface of the unit cell is further improved.

For example, according to an eighteenth aspect of the present disclosure, in the battery according to any one of the fifteenth to seventeenth aspects, the at least one third covering may be a plurality of third coverings, and, among the plurality of third coverings, a third covering that is nearer to an end portion of the side surface of the at least one unit cell in a direction perpendicular to the laminating direction may have a larger coverage area.

In this case, the third covering more strongly binds an end region of the side surface of the unit cell, which tends to become the starting point of interlayer delamination in the unit cell due to repeated charging and discharging and thermal cycle, and therefore interlayer delamination can be suppressed. Thus, it is possible to realize a battery having high reliability.

For example, according to a nineteenth aspect of the present disclosure, in the battery according to any one of the fifteenth to seventeenth aspects, the at least one third covering may be a plurality of third coverings, and, among the plurality of third coverings, a third covering that is nearer to a central portion of the side surface of the at least one unit cell in a direction perpendicular to the laminating direction may have a larger coverage area.

In this case, the third covering more strongly binds the central portion of the unit cell, where interlayer delamination tends to occur due to the effect of a bending stress on the battery, and therefore interlayer delamination at the central portion of the unit cell can be suppressed. Thus, it is possible to realize a battery having high reliability.

For example, according to a twentieth aspect of the present disclosure, in the battery according to any one of the fifteenth to eighteenth aspects, the at least one third covering may be a plurality of third coverings, the plurality of third coverings may include a third covering that covers a corner of the at least one unit cell including an edge of the side surface of the at least one unit cell in a direction perpendicular to the laminating direction, and the third covering that covers the corner may have a largest coverage area among the plurality of third coverings.

In this case, the third covering binds the corner of the unit cell, which particularly tends to become the starting point of interlayer delamination in the unit cell due to repeated charging and discharging and thermal cycle, and therefore interlayer delamination can be further suppressed. Moreover, since the third covering protects the corner of the unit cell, which is fragile, impact resistance is also improved. Thus, it is possible to realize a battery having high reliability.

For example, according to a twenty-first aspect of the present disclosure, in the battery according to any one of the fifteenth to twentieth aspects, the at least one third covering may be a plurality of third coverings, and, among the plurality of third coverings, a third covering that is nearer to a central portion of the battery in the laminating direction may have higher crystallinity.

In this case, the third covering near the central portion of the battery has high thermal conductivity, and therefore it is possible to further promote dissipation of heat of the central portion of the battery. Thus, it is possible to realize a battery having high reliability.

For example, according to a twenty-second aspect of the present disclosure, in the battery according to any one of the fifteenth to twenty-first aspects, a portion of the at least one third covering adjacent to the side surface of the at least one unit cell may have higher crystallinity than a portion of the at least one third covering opposite from the side surface of the at least one unit cell.

In this case, the portion of the third covering adjacent to the side surface of the unit cell has high thermal conductivity, and heat can be transferred to the surface of the third covering with a small loss. Therefore, the performance of heat dissipation from the unit cell through the third covering is improved, and it is possible to further promote dissipation of heat of the battery. Thus, it is possible to realize a battery having high reliability.

For example, according to a twenty-third aspect of the present disclosure, in the battery according to any one of the first to twenty-second aspects, an electrode layer, among the pair of electrode layers of each of the plurality of unit cells, adjacent to the first current collector may be thicker than an electrode layer, among the pair of electrode layers of each of the plurality of unit cells, adjacent to the second current collector.

In this case, the stress of thermal expansion of the first current collector is easily absorbed by the electrode layer that is thick. Therefore, interlayer delamination between the first current collector and the electrode layer, which tends to occur when the first current collector is thick, is suppressed and the thermal shock resistance is improved.

For example, according to a twenty-fourth aspect of the present disclosure, in the battery according to any one of the first to twenty-third aspects, an electrode layer, among the pair of electrode layers of each of the plurality of unit cells, adjacent to the first current collector may include more pores than an electrode layer, among the pair of electrode layers of each of the plurality of unit cells, adjacent to the second current collector.

In this case, the thermal capacity and the heat generation density of an electrode layer near a central portion of the battery are reduced. Thus, heat is not easily accumulated in the central portion of the battery, increase of temperature due to a battery operation is suppressed, and therefore it is possible to realize a battery having high reliability. Moreover, when an electrode layer that is thicker than the other electrode layers includes more pores, it is possible to make the volume of the thick electrode layer to be close to that of the other electrode layers.

For example, according to a twenty-fifth aspect of the present disclosure, in the battery according to any one of the first to twenty-fourth aspects, the number of unit cells in the plurality of unit cells may be greater than or equal to three, and a solid electrolyte layer of a unit cell, among the plurality of unit cells, adjacent to the first current collector and positioned between unit cells positioned at both ends in the laminating direction may be thicker than a solid electrolyte layer of each of the unit cells, among the plurality of unit cells, positioned at both ends in the laminating direction.

In this case, the stress of thermal expansion of the first current collector adjacent to a unit cell at a middle portion, which tends to have a high temperature, can be easily absorbed by the thick solid electrolyte layer. Thus, interlayer delamination between the first current collector and the unit cell, which tends to arise when the first current collector is thick, is suppressed and the thermal shock resistance is improved.

For example, according to a twenty-sixth aspect of the present disclosure, in the battery according to any one of the first to twenty-fifth aspects, the number of unit cells in the plurality of unit cells may be greater than or equal to three, and a solid electrolyte layer of a unit cell, among the plurality of unit cells, adjacent to the first current collector and positioned between unit cells positioned at both ends in the laminating direction may include more pores than a solid electrolyte layer of each of the unit cells, among the plurality of unit cells, positioned at both ends in the laminating direction.

In this case, the thermal capacity of a unit cell at a middle portion, which tends to have a high temperature, is reduced. Thus, heat is not easily accumulated in the unit cell at the middle portion, increase of temperature due to a battery operation is suppressed, and therefore it is possible to realize a battery having high reliability. Moreover, the stress of thermal expansion of the first current collector can be easily absorbed by the solid electrolyte layer having more pores, and a structural defect such as interfacial delamination that tends to occur around the first current collector can be suppressed.

Hereafter, embodiments will be described in detail with reference to the drawings.

The embodiments described below each represent a general or specific example.

The values, shapes, materials, elements, arrangements of elements, connection configurations of elements, and the like described in the following embodiments are examples, and do not limit the present disclosure. Among the elements in the embodiments, elements that are not described in the independent claim are optional elements.

In the present specification, terms that represent the relationships between elements such as “parallel”, terms that represent the shapes of elements such as “rectangular”, and numerical ranges not only have strict meanings but also have meanings of substantially an equivalent range, for example, with a difference of about several percents.

Each figure is not necessarily drawn strictly. Accordingly, for example, the scales and the like do not necessarily coincide with each other between the figures. In the figures, substantially the same configurations are denoted by the same numerals, and redundant descriptions thereof will be omitted or simplified.

In the present specification and the drawings, the x axis, the y axis, and the z axis are the three axes of a three-dimensional orthogonal coordinate system. When the planar shape of a battery is a rectangle, the x axis and the y axis respectively extend in a direction parallel to a first side of the rectangle and a direction parallel to a second side of the rectangle perpendicular to the first side. The z axis extends in the thickness direction of the battery, a unit cell, and a current collector. In the present specification, “thickness direction” is a direction perpendicular to the plane on which each layer is laminated. Therefore, the z axis extends in the laminating direction of a plurality of unit cells and a plurality of current collectors.

In the present specification, “laminating direction” of a battery coincides with a direction perpendicular to a main surface of each layer of a current collector and a unit cell. The term “main surface” refers to the largest-area surface of each element. In the present specification, unless otherwise noted, the term “plan view” refers to a view when seen from a direction perpendicular to the main surface. However, the expression “plan view of a surface (or a region)”, such as “plan view of a side surface”, refers to a view of “a surface (or a region)” when seen from the front.

In the present specification, the terms “above” and “below” in the configuration of a battery do not represent the upward direction (vertically above) and the downward direction (vertically below) in absolute spatial recognition, but are used as terms that are defined by a relative positional relationship based on the laminated order in a laminated configuration. The terms “above” and “below” are used, not only when two elements are disposed with a space therebetween and another element is present between the two elements, but also when two elements are disposed very close to each other and the two elements are in contact with each other. In the following description, the negative side along the z axis will be referred to as “below” or “lower side”, and the positive side along the z axis will be referred to as “above” or “upper side”.

In the present specification, unless otherwise noted, the expression “cover A” means “cover at least a part of A”. That is, “cover A” is an expression including not only “cover the entirety of A” but also “cover only a part of A”. Here, “A” is, for example, a predetermined member such as a unit cell or a layer, a side surface of a predetermined member, a main surface of a predetermined member, or the like.

In the present specification, unless otherwise noted, ordinal numbers, such as “first” and “second”, do not imply the number of elements or the order of elements, and are used in order to avoid confusion between similar elements and to discriminate between the elements.

### EMBODIMENTS

First, a battery according to the present embodiment will be described.

### Overall Structure

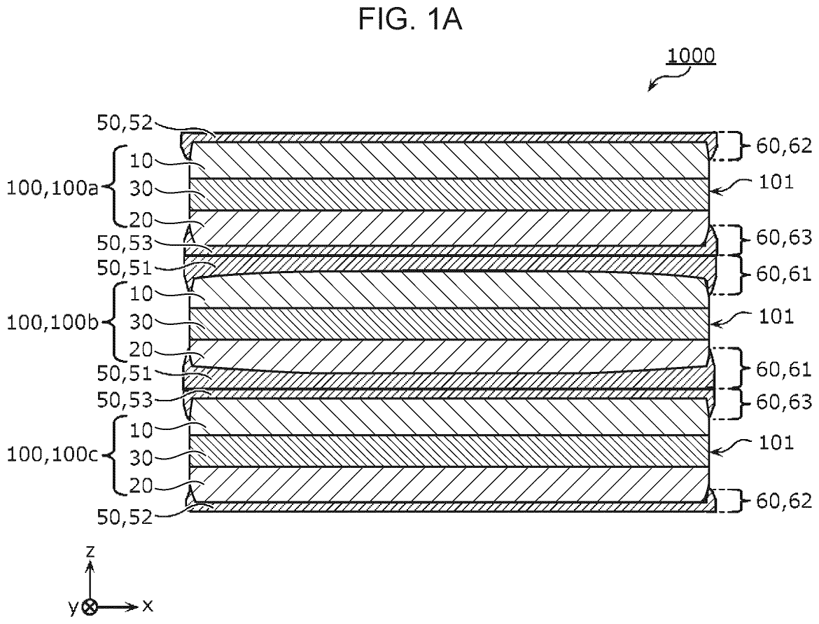

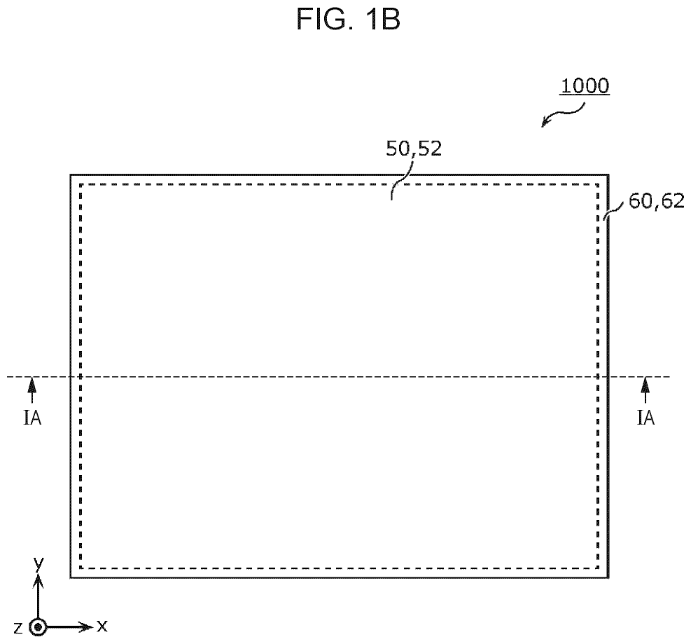

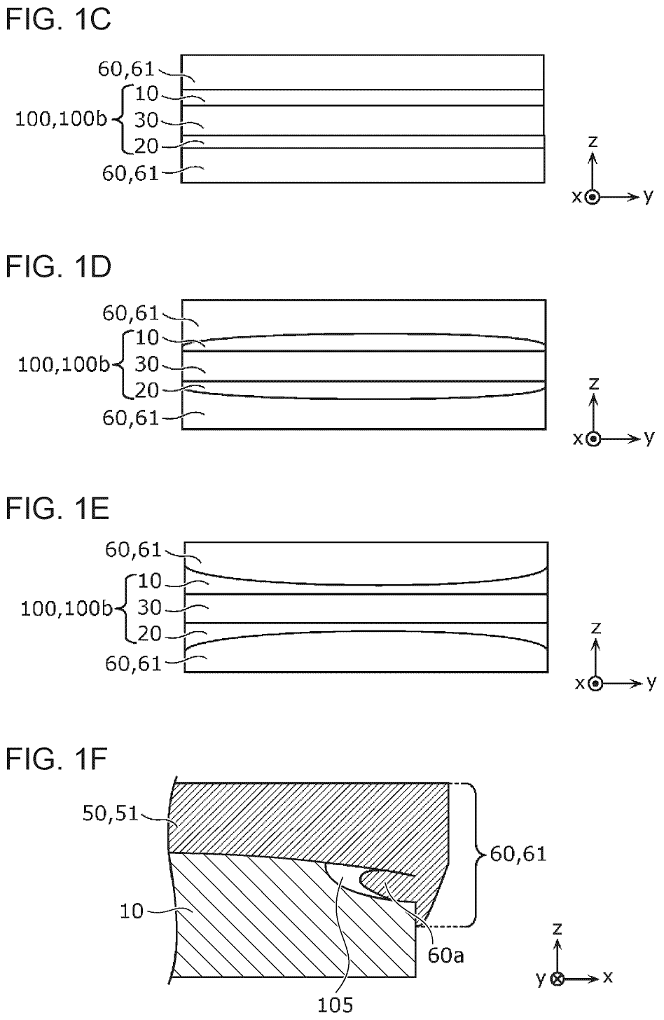

FIG. 1A is a sectional view of a battery 1000 according to the present embodiment. FIG. 1B is a plan view of the battery 1000 according to the present embodiment as seen from above in the z-axis direction. FIG. 1A illustrates a cross section taken along line IA-IA in FIG. 1B. In FIG. 1B, the boundary between a current collector 50 and a covering 60 is shown by a broken line. Also, in other plan views described below, the boundary between the current collector 50 and the covering 60 is shown by a broken line.

As illustrated in FIGS. 1A and 1B, the battery 1000 includes a plurality of unit cells 100, a plurality of current collectors 50, and a plurality of coverings 60. The battery 1000 has a structure such that the plurality of unit cells 100 and the plurality of current collectors 50 are laminated along the z axis. The battery 1000 is, for example, an all-solid-state battery. In the present specification, the plurality of unit cells 100 of the battery 1000 may be distinguished and referred to as a unit cell 100a, a unit cell 100b, and a unit cell 100c in order from the top. The unit cell 100b is an example of a first unit cell. The unit cell 100a and the unit cell 100c are each an example of a second unit cell. Among the plurality of unit cells 100, the unit cell 100a and the unit cell 100c are unit cells 100 that are positioned at both ends in the laminating direction. The unit cell 100b is a unit cell 100 that is interposed between the unit cell 100a and the unit cell 100c at a middle position in the laminating direction.

The planar shape of the battery 1000 is, for example, a rectangle. That is, the schematic shape of the battery 1000 is a flat rectangular-parallelepiped. Here, “flat” means that the thickness (that is, the length in the z-axis direction) is shorter than the length of each side of a main surface (that is, each of the length in the x-axis direction and the length in the y-axis direction) or the maximum width. The planar shape of the battery 1000 may be another polygon such as a square, a hexagon, or an octagon, or may be a circle or an ellipse. Regarding the drawings of the present specification, in the sectional views such as FIG. 1A and the side views such as FIGS. 1C to 1E, the thickness of each layer is exaggerated in order to facilitate understanding of the layered structure of the battery 1000. Also, in the figures for each modification, the thickness of each layer is exaggerated.

The unit cell 100 is the smallest unit of the power generating portion of a battery. A combination of the unit cell 100 and the current collector 50 laminated on the unit cell 100 may be referred to as a unit cell. The plurality of unit cells 100 are laminated together with the plurality of current collectors 50 so as to be electrically connected in series. The plurality of unit cells 100 may be laminated so as to be electrically connected in parallel, or may be laminated so that serial connection and parallel connection coexist.

In the illustrated example, the number of the unit cells 100 included in the battery 1000 is three. However, the number of the unit cells 100 is not limited to this. The number of the unit cells 100 included in the battery 1000 is not particularly limited as long as the number is greater than or equal to two, and the number is determined so that the battery 1000 has a predetermined voltage or a predetermined capacity. When the number of the unit cells 100 is two, the unit cell 100 adjacent to an inner current collector 51 described below and the unit cell 100 adjacent to a surface current collector 52 described below can be the same unit cell 100.

Among the plurality of unit cells 100, two unit cells 100 that are adjacent to each other are laminated with one or more current collectors 50, among the plurality of current collectors 50, therebetween. In the illustrated example, two unit cells 100 that are adjacent to each other are laminated with two current collectors 50 therebetween. Each of the plurality of unit cells 100 is sandwiched between two current collectors 50, among the plurality of current collectors 50, that are adjacent to each other. Each of the plurality of current collectors 50 is a current collector that is laminated on an upper surface or a lower surface of one of the unit cells 100 among the plurality of unit cells 100 and that has substantially the same shape as the upper surface or the lower surface in plan view.

In the battery 1000, for example, the plurality of unit cells 100 have substantially the same shape, substantially the same size, and the same outline in plan view. For example, the plurality of unit cells 100 and the plurality of current collectors 50 have substantially the same shape, the same size, and the same outline in plan view.

### Unit Cell

Each of the plurality of unit cells 100 includes a first electrode layer 10 and a second electrode layer 20 that are a pair of electrode layers whose polarities differ from each other, and a solid electrolyte layer 30 that is positioned between the first electrode layer 10 and the second electrode layer 20. The first electrode layer 10 and the second electrode layer 20 are each an active material layer including an active material. In each of the plurality of unit cells 100, the first electrode layer 10, the solid electrolyte layer 30, and the second electrode layer 20 are laminated in this order along the z axis.

The first electrode layer 10 is one of the positive electrode layer and the negative electrode layer of the unit cell 100. The second electrode layer 20 is the other of the positive electrode layer and the negative electrode layer of the unit cell 100. Hereafter, a case where the first electrode layer 10 is the positive electrode layer and the second electrode layer 20 is the negative electrode layer will be described as an example.

The configurations of the plurality of unit cells 100 are substantially the same as each other. In the battery 1000, the plurality of unit cells 100 are laminated and arranged along the z axis so that the layers of the unit cells 100 are arranged in the same order. Thus, the plurality of unit cells 100 are laminated so as to be electrically connected in series. If the plurality of unit cells 100 are laminated so as to be electrically connected in parallel, the layers are arranged in the opposite order in two unit cells 100 that are adjacent to each other. That is, in this case, the plurality of unit cells 100 are laminated and arranged along the z axis so that the order of the layers in the unit cells 100 changes alternately.

The first electrode layer 10 is laminated on the current collector 50 adjacent thereto, and is in contact with a main surface of the current collector 50. In the present embodiment, the first electrode layer 10 covers the entirety of the main surface of the current collector 50. In the present embodiment, the first electrode layer 10, which is the positive electrode layer, includes at least a positive-electrode active material. That is, the first electrode layer 10 is a positive-electrode active material layer that is mainly made of a positive-electrode material such as a positive-electrode active material. The positive-electrode active material layer is made of, for example, a powdery material.

The positive-electrode active material layer includes at least a positive-electrode active material. That is, the positive-electrode active material layer is a layer that is mainly made of a positive-electrode material such as a positive-electrode active material. The positive-electrode active material is a material in which metal ions such as lithium (Li) ions or magnesium (Mg) ions are inserted into or removed from a crystal structure at an electric potential higher than that of the negative electrode and oxidation or reduction is performed accordingly. The type of the positive-electrode material can be appropriately selected in accordance with the type of the battery 1000, and a known positive-electrode active material can be used.

Examples of the positive-electrode active material include a chemical compound including lithium and a transition metal element, such as an oxide including lithium and a transition metal element or a phosphate compound including lithium and a transition metal element. As the oxide including lithium and a transition metal element, for example, any of the following can be used: a lithium-nickel composite oxide such as LiNiₓM₁₋ₓO₂ (where M is at least one selected from the group consisting of Co, Al, Mn, V, Cr, Mg, Ca, Ti, Zr, Nb, Mo, and W, and where x satisfies 0<x≤1); a layered oxide such as lithium cobaltite (LiCoO₂), lithium nickelate (LiNiO₂), or lithium manganese (LiMn₂O₄); a lithium manganate having a spinel structure (such as LiMn₂O₄, LizMnO₃, or LiMnO₂); and the like. As the phosphate compound including lithium and a transition metal element, for example, lithium iron phosphate having an olivine structure (LiFePO₄) can be used. As the positive-electrode active material, sulfur(S) or a sulfide such as lithium sulfide (Li₂S) can be used. In this case, particles of the positive-electrode active material coated with lithium niobate (LiNbO₃) or particles of the positive-electrode active material to which lithium niobate is added can be used as the positive-electrode active material. As the positive-electrode active material, only one of these materials may be used, or a combination of two or more of these materials may be used.

As described above, it is sufficient that the positive-electrode active material layer include at least a positive-electrode active material. The positive-electrode active material layer may be a mixture layer made of a mixture of a positive-electrode active material and another additive material. As the additive material, it is possible to use, for example, a solid electrolyte such as an inorganic-material-based solid electrolyte or a sulfide-based solid electrolyte, an electroconductive auxiliary material such as acetylene black, a binder such as polyethylene oxide or polyvinylidene fluoride, or the like. By mixing another additive material, such as a solid electrolyte, with the positive-electrode active material of the positive-electrode active material layer in a predetermined ratio, it is possible to improve the ion conductivity and the electron conductivity in the positive-electrode active material layer.

The thickness of the positive-electrode active material layer is, for example, greater than or equal to 5 μm and less than or equal to 300 μm, but the thickness is not limited to this.

The second electrode layer 20 is laminated on the current collector 50 adjacent thereto, and is in contact with a main surface of the current collector 50. The second electrode layer 20 is disposed so as to face the first electrode layer 10 with the solid electrolyte layer 30 therebetween. In the present embodiment, the second electrode layer 20 covers the entirety of the main surface of the current collector 50. In the present embodiment, since the second electrode layer 20, which is the negative-electrode active material layer, includes at least a negative-electrode active material. That is, the second electrode layer 20 is a negative-electrode active material layer that is mainly made of a negative-electrode material such as a negative-electrode active material. The negative-electrode active material layer is made of, for example, a powdery material.

The negative-electrode active material is a material in which metal ions such as lithium (Li) ions or magnesium (Mg) ions are inserted into or removed from a crystal structure at an electric potential lower than that of the positive electrode and oxidation or reduction is performed accordingly. The type of the negative-electrode material can be appropriately selected in accordance with the type of the battery 1000, and a known negative-electrode active material can be used.

As the negative-electrode active material, it is possible to use, for example, a carbon material such as natural graphite, synthetic graphite, graphite carbon fiber, or resin-baked carbon; or an alloy-based material mixed with a solid electrolyte. As the alloy-based material, it is possible to use, for example, a lithium alloy such as LiAl, LiZn, Li₃Bi, Li₃Cd, Li₃Sb, Li₄Si, Li_{4.4}Pb, Li_{4.4}Sn, Li_{0.17}C, or LiC₆; an oxide of lithium and a transition metal element such as lithium titanate (Li₄Ti₅O₁₂); a metal oxide such as zinc oxide (ZnO) or silicon oxide (SiOx); or the like. As the negative-electrode active material, only one of these materials may be used or a combination of two or more of these materials may be used.

As described above, it is sufficient that the negative-electrode active material layer include at least a negative-electrode active material. The negative-electrode active material layer may be a mixture layer made of a mixture of a negative-electrode active material and another additive material. As another additive material it is possible to use, for example, a solid electrolyte such as an inorganic-material-based solid electrolyte or a sulfide-based solid electrolyte, an electroconductive auxiliary material such as acetylene black, a binder such as polyethylene oxide or polyvinylidene fluoride, or the like. By mixing another additive material, such as a solid electrolyte, with the negative-electrode active material of the negative-electrode active material layer in a predetermined ratio, it is possible to improve the ion conductivity and the electron conductivity in the negative-electrode active material layer.

The thickness of the negative-electrode active material layer is, for example, greater than or equal to 5 μm and less than or equal to 300 μm, but the thickness is not limited to this.

The solid electrolyte layer 30 is disposed between the first electrode layer 10 and the second electrode layer 20, and is in contact with the first electrode layer 10 and the second electrode layer 20. The solid electrolyte layer 30 includes at least a solid electrolyte.

The solid electrolyte may be a known ion-conductive solid electrolyte for a battery. As the solid electrolyte, for example, a solid electrolyte that conducts metal ions, such as lithium ions or magnesium ions, can be used. The type of the solid electrolyte may be appropriately selected in accordance with the type of ions to be conducted.

As the solid electrolyte, an inorganic solid electrolyte, such as a sulfide solid electrolyte or an oxide solid electrolyte, can be used. As the sulfide-based solid electrolyte is, it is possible to use a lithium-containing sulfide that is, for example, Li₂S—P₂S₅-based, Li₂S—SiS₂-based, Li₂S—B₂S₃-based, Li₂S—GeS₂-based, Li₂S—SiS₂—LiI-based, Li₂S—SiS₂—Li₃PO₄-based, Li₂S—Ge₂S₂-based, Li₂S—GeS₂—P₂S₅-based, or Li₂S—GeS₂—ZnS-based. As the oxide solid electrolyte, it is possible to use, for example, a lithium-containing metal oxide such as Li₂O—SiO₂ or Li₂O—SiO₂—P₂O₅, a lithium-containing metal nitride such as LiₓP_{y}O_{1-z}N₂, lithium phosphate (Li₃PO₄), or a lithium-containing transition-metal oxide such as a lithium-titanium oxide. As the solid electrolyte, only one of these materials may be used, or a combination of two or more of these materials may be used. In the present embodiment, the solid electrolyte layer 30 includes, as an example, a solid electrolyte having lithium-ion conductivity.

The solid electrolyte layer 30 may include, in addition to the solid electrolyte, a binder such as polyethylene oxide or polyvinylidene fluoride.

The thickness of the solid electrolyte layer 30 is, for example, greater than or equal to 5 μm and less than or equal to 500 μm, but the thickness is not limited to this.

The solid electrolyte layer 30 may be composed of aggregates of particles of a solid electrolyte particle. The solid electrolyte layer 30 may be composed of sintered structures of a solid electrolyte.

In each unit cell 100, for example, the first electrode layer 10, the solid electrolyte layer 30, and the second electrode layer 20 have substantially the same shape, the same size, and the same outline in plan view.

The first electrode layer 10 may be a negative electrode layer, and the second electrode layer 20 may be a positive electrode layer.

### Current Collector

It is sufficient that the plurality of current collectors 50 be each made of an electroconductive material such as a metal, and the material is not particularly limited. The plurality of current collectors 50 each include, for example, a metal. Each current collector 50 is, for example, a foil-shaped member, a plate-shaped member, or the like that is made of stainless steel, nickel (Ni), aluminum (Al), iron (Fe), titanium (Ti), copper (Cu), palladium (Pd), gold (Au), platinum (Pt), or an alloy of two or more of these. One current collector 50 is composed of, for example, one metal foil. The material of each current collector 50 may be appropriately selected in consideration of resistance to decomposition or melting in a manufacturing process, at the operating temperature, and at the operating pressure, and the operating electric potential of the battery applied to each current collector 50 and electroconductivity. The material of each current collector 50 can be selected also in accordance with the required tensile strength or the required heat resistance. Each current collector 50 may be a high-strength electrolytic copper foil or a cladding member that is formed by, after laminating foils of different metals, bonding and heat-treating the foils so as to form a single metal foil. The plurality of current collectors 50 may include current collectors 50 made of materials that differ from each other. For example, a current collector 50 that is adjacent to the first electrode layer 10 and a current collector 50 that is adjacent to the second electrode layer 20 may be made of different materials.

In order to increase the closeness of contact with the electrode layer, the current collector 50 may be treated to have a rough surface having protrusions and recesses. To the surface of the current collector 50, an adhesive component such as an organic binder having electroconductivity may be applied. Thus, the bondability at the interface between the current collector 50 and another layer is increased, and it is possible to increase the mechanical reliability, the thermal reliability, the charge-discharge cycle characteristics, and the like of the battery 1000.

The plurality of current collectors 50 include: inner current collectors 51 and 53 that are positioned between the plurality of unit cells 100; and a surface current collector 52 that is positioned at a surface portion (in other words, an end portion) in the laminating direction of a laminated structure in which the plurality of unit cells 100 and the plurality of current collectors 50 are laminated. In the present specification, the plurality of current collectors 50 of the battery 1000 may be distinguished and referred to as the inner current collector 51, the surface current collector 52, and the inner current collector 53. The inner current collector 51 is an example of a first current collector. The surface current collector 52 is an example of a second current collector.

The surface current collectors 52 are disposed above the unit cell 100a, which is positioned at the top among the plurality of unit cells 100, and below the unit cell 100c, which is positioned at the bottom among the plurality of unit cells 100. That is, the surface current collectors 52 are disposed at both ends of the battery 1000 in the laminating direction. Each surface current collector 52 has, for example, a uniform thickness. The thickness of the surface current collector 52 is, for example, greater than or equal to 10 μm and less than or equal to 100 μm.

In the present embodiment, the inner current collector 51 and the inner current collector 53 are disposed between each pair of adjacent unit cells 100. To be more specific, the inner current collector 51 and the inner current collector 53 are disposed at each of a position between the unit cell 100a and the unit cell 100b and a position between the unit cell 100b and the unit cell 100c. The inner current collector 51 is in contact with the unit cell 100b. The inner current collector 53 is in contact with the unit cell 100a or the unit cell 100c. The inner current collector 51 and the inner current collector 53 that are adjacent to each other are bonded, for example, by using an electroconductive resin (not shown). However, the inner current collector 51 and the inner current collector 53 that are adjacent to each other may be only in contact with each other.

An end portion of the inner current collector 51 is thicker than a central portion of the inner current collector 51. To be more specific, the entire end portion of the inner current collector 51 in the x-axis direction and the y-axis direction that are perpendicular to the laminating direction (that is, the peripheral portion of the inner current collector 51 in plan view) is thicker than the central portion of the inner current collector 51. The thickness of the inner current collector 51 increases from the central portion toward the end portion. The thickness of the end portion of the inner current collector 51 is, for example, greater than or equal to 101% and less than or equal to 120% of the thickness of the central portion of the inner current collector 51. Since the end portion of the inner current collector 51 is thicker than the central portion of the inner current collector 51, the end portion of the inner current collector 51, from which heat is dissipated to the outside, is large, and therefore heat dissipation from the battery 1000 is promoted. It is sufficient that only an end portion of the inner current collector 51 in a direction perpendicular to the laminating direction be thicker than the central portion.

The inner current collector 51, whose end portion is thicker than the central portion, can be formed by, for example, press-molding using a die corresponding to the shape of the inner current collector 51. However, a method of forming the inner current collector 51 is not particularly limited. For example, the inner current collector 51 may be formed by using a method other than press-molding using the die, such as applying a stress to a metal foil, plating, or the like.

At least a part of the inner current collector 51 is thicker than the surface current collector 52. The average thickness of the inner current collector 51 is, for example, larger than the average thickness of the surface current collector 52. In the illustrated example, the entirety of the inner current collector 51 is thicker than the surface current collector 52. Thus, dissipation of heat from a portion near the center of the battery 1000 (for example, the unit cell 100b), where the operation temperature is high and characteristic deterioration tends to occur, is promoted, and it is possible to increase the reliability of the battery 1000. The average thickness of the inner current collector 51 is, for example, greater than or equal to 110% and less than or equal to 120% of the average thickness of the surface current collector 52.

The inner current collector 53 has, for example, a thickness characteristic similar to that of the surface current collector 52. The plurality of current collectors 50 may include the inner current collector 51 instead of the inner current collector 53. It is sufficient that the plurality of current collectors 50 include at least one inner current collector 51.

At least a part of the inner current collectors 51 and 53 has, for example, higher crystallinity than the surface current collector 52. More than a half of the inner current collectors 51 and 53 may have higher crystallinity than the surface current collector 52, or the entirety of the inner current collectors 51 and 53 may have higher crystallinity than the surface current collector 52. Thus, the thermal conductivity of the inner current collectors 51 and 53 is further increased, and therefore the heat dissipation performance can be further increased. This is because a metal has low thermal resistance and low electrical resistance when the metal has high crystallinity and few defects. In the present specification, the crystallinity of the current collector 50 and a covering 60 described below is the crystallinity of a metal included in the current collector 50 and the covering 60. The expression “crystallinity is higher or lower” means that crystallinity is higher or lower than that of any portion of a comparison target. The “any portion of a comparison target” is the entire portion of a substantial comparison target and does not include a small region that is 3% or smaller of the comparison target and in which crystallinity is different from those of other portions.

It is possible to evaluate the crystallinity of a metal included the current collector 50 by, for example, observing a crystal lattice image obtained by using a TEM (Transmission Electron Microscope). It is also possible to compare and evaluate the crystallinity of a metal included the current collector 50 from the spread of a diffraction peak in micro-focus XRD (X-Ray Diffraction). In this case, a portion where a broader diffraction peak is detected has lower crystallinity. Since a portion with lower crystallinity is softer, for example, it is also possible to alternatively compare and evaluate crystallinity by comparing and evaluating softness by performing a micro-Vickers hardness test or the like.

It is possible to improve the crystallinity of the current collector 50 by, for example, heat treatment. For example, it is possible to improve the crystallinity by heat-treating the current collector 50 at a temperature lower than or equal to a half of the melting point of a metal material, such as a temperature higher than or equal to 150° C. and lower than or equal to 350° C., in a non-oxidizing atmosphere such as a nitrogen atmosphere. It is also possible to selectively control the crystallinity of only a partial region of the current collector 50, such as a central portion or an end portion of the current collector 50, by performing partial heat treatment.

### Covering

The plurality of coverings 60 are each a layer that covers a side surface 101 of the unit cell 100. The side surface 101 is a surface that connects an upper surface and a lower surface, which are the two main surfaces, of the unit cell 100. When the unit cell 100 has a rectangular-parallelepiped shape, the unit cell 100 has four flat side surfaces 101 as the side surfaces. The plurality of coverings 60 are each continuous with an end portion of a corresponding one of the plurality of current collectors 50, extends from the end portion of the current collector 50 along the side surface 101 of a unit cell 100 that is adjacent to the current collector 50, and covers a part of the side surface 101 of the unit cell 100. In the example illustrated in FIG. 1A, each covering 60 extends in the z-axis direction. The current collector 50 and the covering 60 continuous with the current collector 50 are integrally formed, and the current collector 50 and the covering 60 continuous with the current collector 50 are made of the same continuous material such as the same metal conductor. That is, each covering 60 is made of one of the materials listed above as examples of the material of the current collector 50. In the battery 1000, the covering 60 is formed for each of the plurality of current collectors 50.

Since the covering 60 covers the side surface 101 of the unit cell 100, the covering 60, which has a higher thermal conductivity than the unit cell 100, promotes heat dissipation from the unit cell 100 while covering the side surface 101 of the unit cell 100, and it is possible to increase the reliability of the battery 1000. To be specific, heat generated in the unit cell 100 is transferred, via the current collector 50 having a high thermal conductivity, to the covering 60, which is exposed while covering the side surface 101 of the unit cell 100 (to be specific, the side surfaces of the first electrode layer 10 or the second electrode layer 20). As a result, the heat is dissipated to the outside of the battery 1000 from the covering 60, which has a higher thermal conductivity than the first electrode layer 10 or the second electrode layer 20, which is mainly made of an oxide or the like. Thus, compared with a case where the side surface of the first electrode layer 10 or the second electrode layer 20 is not covered by the covering 60, it is possible to promote heat dissipation from the battery 1000 and to increase the reliability of the battery 1000.

Since the covering 60, which extends from the current collector 50 laminated on the unit cell 100, covers the side surface 101 of the unit cell 100, the interface between the current collector 50 and the unit cell 100 is covered the covering 60 from the side, and thus the current collector 50 and the unit cell 100 (to be specific, the first electrode layer 10 or the second electrode layer 20) are bound. Thus, interlayer delamination of the current collector 50 and the unit cell 100 at the interface between the current collector 50 and the unit cell 100, where delamination tends to occur, can be suppressed.

Each covering 60 covers, for example, in plan view of the side surface 101, a part of the side surface 101 from one end to the other end of the side surface 101 in a direction perpendicular to the laminating direction. Each covering 60 is formed, for example, to be continuous with the entire end portion of the current collector 50 in the x-axis direction and the y-axis direction that are perpendicular to the laminating direction (that is, the peripheral portion of the current collector 50 in plan view), and covers the entire periphery of the side surface of the unit cell 100 in plan view. Although only the uppermost covering 60 (a surface covering 62 described below) is illustrated in FIG. 1B, the other coverings 60 are formed at the same position as the uppermost covering 60 in plan view. The covering 60 may cover a part of the entire periphery of the side surface of the unit cell 100 in plan view. In order to suppress warping, deformation, and the like, the covering 60 has, for example, a shape that is symmetric with respect to the unit cell 100 in plan view.

Each covering 60 covers, for example, a corner of the unit cell 100. A corner of the unit cell 100 is, for example, a portion including an edge of the side surface 101 in a direction perpendicular to the laminating direction in plan view of the side surface 101 of the unit cell 100, and can be said to be a ridge of the unit cell 100 that connects the upper and lower surfaces of the unit cell 100. Since the covering 60 covers the corner of the unit cell 100, the covering 60 binds the corner of the unit cell 100, which tends to become the starting point of interlayer delamination due repeated charging and discharging, and therefore interlayer delamination can be suppressed. Moreover, since the covering 60 protects the corner of the unit cell 100, which is fragile, impact resistance is improved.

Each covering 60 covers, for example, a part of the side surface of the first electrode layer 10 or a part of the side surface of the second electrode layer 20 adjacent to the current collector 50 continuous with the covering 60. The area of the covering 60 that covers an electrode layer, among the first electrode layer 10 and the second electrode layer 20, that generates a larger amount of heat may be larger than the area of the covering 60 that covers an electrode layer, among the first electrode layer 10 and the second electrode layer 20, that generates a smaller amount of heat. Thus, generation of heat by the battery 1000 can be further suppressed.

In each covering 60, the thickness of the covering 60 decreases toward the distal end in the extension direction of the covering 60, that is, in a direction away from the current collector 50. The extension direction of the covering 60 coincides with the laminating direction. The thickness of the covering 60 may be uniform. The thickness direction of the covering 60 is a direction perpendicular to the side surface 101.

The plurality of coverings 60 are each in contact with the side surface 101 of the unit cell 100. For example, the plurality of coverings 60 are each in close contact with the side surface of the first electrode layer 10 or the side surface of the second electrode layer 20 made of a powdery material, and each penetrate into very small protrusions and recesses in the side surface. Illustration of the protrusions and recesses, which are very small, is omitted. The degree of penetration of the covering 60 is, for example, greater than or equal to 0.1 μm and less than or equal to 1.0 μm. This corresponds to the surface roughness (Rz) of the side surface of the first electrode layer 10 or the side surface of the second electrode layer 20. In this way, in order to cause the covering 60 to follow and be in close contact with the protrusions and recesses of the side surface of the first electrode layer 10 or the side surface of the second electrode layer 20, it is desirable to reduce the crystallinity and increase the deformability of (that is, soften) a metal included in the covering 60. When an external stress such as a deforming stress is applied, the crystallinity of a polycrystalline structure of a metal material decreases as a lattice defect such as dislocation and irregularity in lattice arrangement occur. Moreover, when an external stress such as a deforming stress is applied, interfacial defects between crystal grains also increase. Thus, the plastic deformability of the metal increases.

A method of forming the covering 60 is not particularly limited, and various metalworking methods can be used. Each covering 60 is formed by, for example, causing the current collector 50 to protrude beyond the side surface 101, and brushing or polishing (or rubbing) the protruding portion of the current collector 50 while applying a pressure that does not break the unit cell 100 to the protruding portion. Thus, the covering 60 is formed while being deformed and the crystallinity of the covering 60 is reduced from the side of a surface opposite from the side surface 101, and the covering 60 comes into close contact with the side surface 101. For brushing, for example, a nylon brush or a polyester blush whose bristle diameter ϕ is greater than or equal to 30 μm and less than or equal to 200 μm is used. For polishing, for example, sandpaper of #1500 to #3000 is used. It is possible to selectively perform treatment, such as brushing or polishing, by masking a portion not to be treated by using a film, a metal mask, or the like.

For example, by making the covering 60 in this way, the covering 60 can be formed to protrude beyond the side surface 101 by, for example, greater than or equal to 0.3 μm and less than or equal to 3 μm. The plurality of coverings 60 may include a covering 60 at least a part of which is embedded in the side surface 101 of the unit cell 100. For example, at least a part of an inner covering 61 described below may be embedded in the side surface 101 of the unit cell 100. Thus, the bondability between the covering 60 and the side surface 101 is improved, and delamination of the current collector 50 and the unit cell 100 can be further suppressed.

When the plurality of coverings 60 are formed by using the method described above, in each covering 60, a portion of the covering 60 adjacent to the side surface 101 of the unit cell 100 has higher crystallinity than a portion, which is an exposed portion, of the covering 60 opposite from the side surface 101. Thus, the thermal resistance of the portion of the covering 60 adjacent to the unit cell 100 is low, and the heat dissipation performance of the battery 1000 is improved. It is possible to evaluate the crystallinity of a metal included in the covering 60 by using a method that is similar to the aforementioned method of evaluating the crystallinity of a metal included in the current collector 50. It is possible to observe a defective structure of the interface between crystal grains (very small delamination at the interface) by using a SEM (Scanning Electron Microscope) image.

When the plurality of coverings 60 are formed by using the method described above, in each covering 60, at least a part of the covering 60 has lower crystallinity than the current collector 50 continuous with the covering 60. Thus, for example, since a portion of the covering 60 that covers the side surface 101 has low crystallinity, the portion is soft, and the closeness of contact between the side surface 101 and the covering 60 is improved. In each covering 60, more than a half of the covering 60 may have lower crystallinity than the current collector 50 continuous with the covering 60.

When the plurality of coverings 60 are formed by using the method described above, in each covering 60, a distal end portion of the covering 60 in the extension direction has lower crystallinity than a portion of the covering 60 continuous with the current collector 50. Thus, since the distal end portion of the covering 60, which tends to become the starting point of peeling of the covering 60 from the side surface 101, is soft, the bonding strength between the distal end portion and the side surface 101 is increased, and peeling of the covering 60 is suppressed.

The length of a portion of each of the plurality of coverings 60 that covers the side surface 101 in the extension direction is, for example, less than or equal to the thickness of the first electrode layer 10 and the second electrode layer 20. To be specific, the length of a portion of each of the plurality of coverings 60 that covers the side surface 101 in the extension direction is, for example, greater than or equal to 1 μm and less than or equal to 300 μm. If the covering 60 does not cover the side surfaces of both of the first electrode layer 10 and the second electrode layer 20, the covering 60 may extend to and cover a part of the side surface of the solid electrolyte layer 30.

The plurality of coverings 60 include an inner covering 61 continuous with the inner current collector 51, an inner covering 63 continuous with the inner current collector 53, and a surface covering 62 continuous with the surface current collector 52. The inner covering 61 is an example of a first covering. The surface covering 62 is an example of a second covering. The inner covering 61 and the inner current collector 51 are integrally formed. The inner covering 63 and the inner current collector 53 are integrally formed. The surface covering 62 and the surface current collector 52 are integrally formed. The inner covering 61, which is continuous with the inner current collectors 51, and the inner covering 63, which is continuous with the inner current collector 53, that are adjacent to each other may be integrated by pressure and heat that are generated when being processed.

The inner covering 61 covers the side surface 101 of the unit cell 100b, among the plurality of unit cells 100, adjacent to the inner current collector 51. The inner covering 63 covers the side surface 101 of the unit cell 100a or the unit cell 100c, among the plurality of unit cells 100, adjacent to the inner current collector 53. The surface covering 62 covers the side surface 101 of the unit cell 100a or the unit cell 100c, among the plurality of unit cells 100, adjacent to the surface current collector 52.

At least a part of the inner covering 61 has higher crystallinity than the surface covering 62. Thus, the inner covering 61, which is continuous with the inner current collector 51, has high thermal conductivity, and therefore it is possible to further promote dissipation of heat of the inside of the battery 1000. The inner covering 61 having higher crystallinity than the surface covering 62 can be formed from, for example, the inner current collector 51 having higher crystallinity than the surface current collector 52. Likewise, at least a part of the inner covering 63 may have higher crystallinity than the surface covering 62.

The length of the inner covering 61 in the extension direction (the distance between broken lines shown in FIG. 1A) is, for example, larger than the length of the surface covering 62 in the extension direction. As described below, if the length of the covering 60 in the extension direction is not uniform, this length is an average length. Thus, the coverage area of the inner covering 61, which is continuous with the inner current collector 51, is large, and it is possible to further promote dissipation of heat of the inside of the battery 1000. Likewise, the length of the inner covering 63 in the extension direction may be larger than the length of the surface covering 62 in the extension direction.

Here, the length of the covering 60 in the extension direction will be described in detail. FIGS. 1C to 1E are side views illustrating examples of the planar shape of the inner covering 61. FIGS. 1C to 1E each illustrate the shape of the inner covering 61 when the side surface 101 of the unit cell 100b is seen from the front in plan view. FIGS. 1C to 1E each illustrate a region from one end to the other end of the side surface 101 in a direction perpendicular to the laminating direction. Referring to FIGS. 1C to 1E, only the length of the inner covering 61 in the extension direction will be described. However, the surface covering 62 and the inner covering 63 each may have a length characteristic in the extension direction similar to that of the inner covering 61.

As illustrated in FIG. 1C, the length of the inner covering 61 in the extension direction may be uniform.

As illustrated in FIG. 1D, the length of the inner covering 61 in the extension direction may be larger in both end portions of the inner covering 61 in a direction perpendicular to the laminating direction than in a central portion of the inner covering 61 in the direction perpendicular to the laminating direction. Thus, the inner covering 61 more strongly binds end portions of the side surface 101, which tend to become the starting point of interlayer delamination due to repeated charging and discharging and thermal cycle, and therefore interlayer delamination can be suppressed.

As illustrated in FIG. 1E, the length of the inner covering 61 in the extension direction may be larger in a central portion of the inner covering 61 in the direction perpendicular to the laminating direction than in both end portions of the inner covering 61 in the direction perpendicular to the laminating direction. Thus, the inner covering 61 more strongly binds the central portion of the side surface 101, where interlayer delamination tends to occur due to the effect of a bending stress on the battery 1000, and therefore interlayer delamination can be suppressed. In particular, such a configuration is effective when the battery 1000 is a large battery, in which the bending stress tends to large.

The covering 60 is also effective in increasing the reliability of the battery 1000 when a gap is formed in an end portion between the unit cell 100 and the current collector 50. FIG. 1F is an enlarged sectional view illustrating a state in which a gap 105 is formed between the unit cell 100 and the current collector 50. FIG. 1F illustrates a state in which the gap 105 is formed in an end portion between the inner current collector 51 and the unit cell 100 (to be specific, the first electrode layer 10) and the inner covering 61 covers the gap 105. Referring to FIG. 1F, only a case where the inner covering 61 covers the gap 105 will be described. However, as with the inner covering 61, the surface covering 62 and the inner covering 63 may also cover the gap 105.

As illustrated in FIG. 1F, the inner covering 61 covers the gap 105 and, for example, seals the gap 105. Thus, the inner covering 61 blocks entry of a sulfide gas, water, and the like, which may deteriorate the characteristics of the battery 1000, into the gap 105. Although the gap 105 tends to become the starting point of delamination at the interface between the inner current collector 51 and the unit cell 100, the delamination can be suppressed by the inner covering 61.

The inner covering 61 may include a portion 60a that fills the gap 105. Thus, it is possible to increase the effect of the inner covering 61 in sealing the gap 105.

### Advantageous Effects Etc.

With the configuration described above, due to the presence of the inner current collector 51, dissipation of heat from a central portion of the battery 1000, where the operation temperature is high and characteristic deterioration tends to occur, is promoted, and it is possible to realize the battery 1000 having high reliability. Dissipation of heat from the battery 1000 can be promoted also because the battery 1000 includes the covering 60.

The configuration of the battery 1000 according to the present embodiment differs from the configurations of the batteries described in Japanese Unexamined Patent Application Publication Nos. 8-78025 and 2008-123955 in the following respects. Japanese Unexamined Patent Application Publication No. 8-78025 discloses a laminated battery in which unit cells are laminated and connected in series. However, the laminated battery described in Japanese Unexamined Patent Application Publication No. 8-78025 has a configuration such that a plurality of current collectors and a plurality of unit cells whose thicknesses are each uniform and whose thicknesses are the same as each other are laminated, and does not have a covering that is continuous with a current collector and that covers a side surface of a unit cell. That is, the laminated battery described in Japanese Unexamined Patent Application Publication No. 8-78025 differs from the battery 1000 in that an inner current collector and a surface current collector have the same thickness and the laminated battery does not have a covering that covers a side surface of a unit cell.

With the configuration described in Japanese Unexamined Patent Application Publication No. 8-78025, heat tends to accumulate in the multilayered unit cells due to charging and discharging operations, and the battery performance deteriorates easily. Moreover, the laminated battery has a problem in that delamination tends to occur at the interface between a current collector and an electrode layer due to repeated expansion and contraction of the electrode layer. Thus, characteristic deterioration of the battery tends to progress due to the effect of heat generation and structural defect caused by repeated charging and discharging. Such a problem regarding the reliability frequently arises as the capacity and the energy of the battery increase when, for example, the amount of an active material and the number of laminated unit cells increase.

Japanese Unexamined Patent Application Publication No. 2008-123955 discloses a serially-connected laminated battery including a bipolar electrode in which a positive electrode layer and a negative electrode layer are formed on the front and back surfaces of a current collector. However, in the laminated battery described in Japanese Unexamined Patent Application Publication No. 2008-123955, an inner current collector and a surface current collector have the same thickness, and a covering that covers a side surface of a unit cell is not formed. Accordingly, deterioration of the battery performance and a structural defect tend to occur due to charging and discharging operations, and the battery has a problem similar to that of the configuration of Japanese Unexamined Patent Application Publication No. 8-78025.

In contrast, with the battery 1000 according to the present embodiment, the above problems do not occur. Moreover, Japanese Unexamined Patent Application Publication Nos. 8-78025 and 2008-123955 do not disclose or suggest the following features described in the present embodiment: the inner current collector 51 is thicker than the surface current collector 52; and the covering 60 that is continuous with the current collector 50 and that covers the side surface 101.

### First Modification

Hereafter, a first modification of the embodiment will be described. In the following description of the first modification, differences from the embodiment will be mainly described, and description of common features will be omitted or simplified. Also, in the following description of each of the second to tenth modifications, differences between the embodiment and the modification will be mainly described, and description of common features will be omitted or simplified.

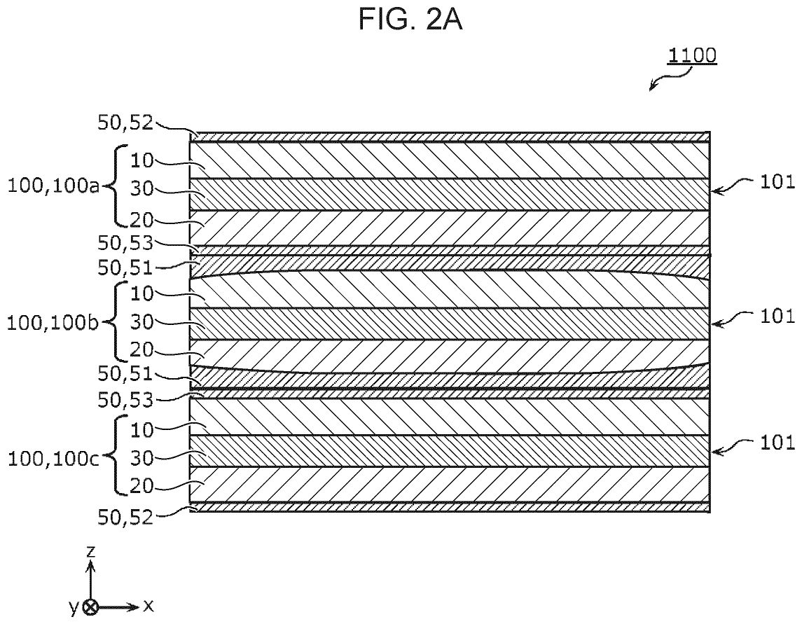

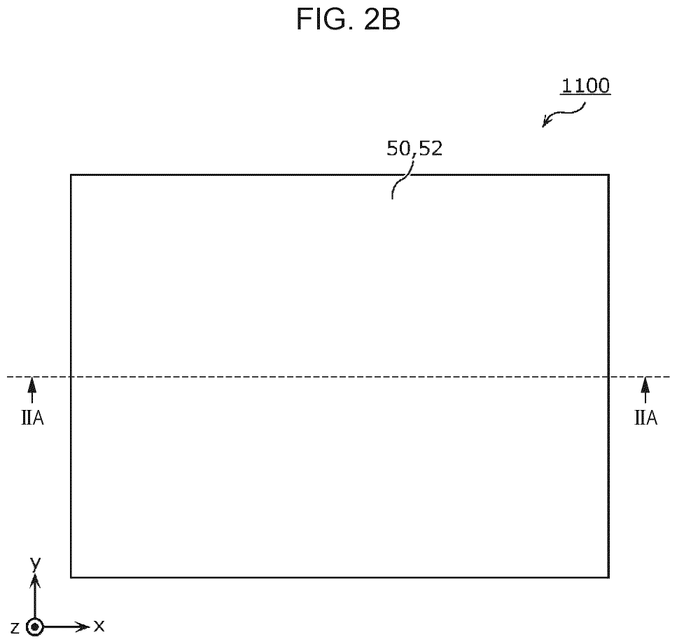

FIG. 2A is a sectional view of a battery 1100 according to the present modification. FIG. 2B is a plan view of the battery 1100 according to the present modification as seen from above in the z-axis direction. FIG. 2A illustrates a cross section taken along line IIA-IIA in FIG. 2B.

As illustrated in FIGS. 2A and 2B, the battery 1100 according to the present modification differs from the battery 1000 according to the embodiment in that the battery 1100 does not include the plurality of coverings 60.

Also in the battery 1100, as with the battery 1000, the inner current collector 51 is thicker than the surface current collector 52, and the end portions of the inner current collector 51 are thicker than the central portion of the inner current collector 51. Therefore, dissipation of heat from the central portion of the battery 1100 is promoted, and it is possible to increase the reliability of the battery 1100.

In the battery 1100, the side surfaces (end surfaces) of the plurality of current collectors 50 are exposed, and the side surfaces of the plurality of current collectors 50 and the side surfaces 101 of the plurality of unit cells 100 are flush with each other and constitute the flat side surface of the battery 1100. Therefore, when an additional layer or the like is to be formed on the side surface of the battery 1100 in order to, for example, protect the side surface of the battery 1100 from dust, gas, water, and the like by using an insulating resin or the like, it is easy to form the shape and the thickness with high precision (for example, by application, printing, or the like).

### Second Modification

Next, a second modification of the embodiment will be described.

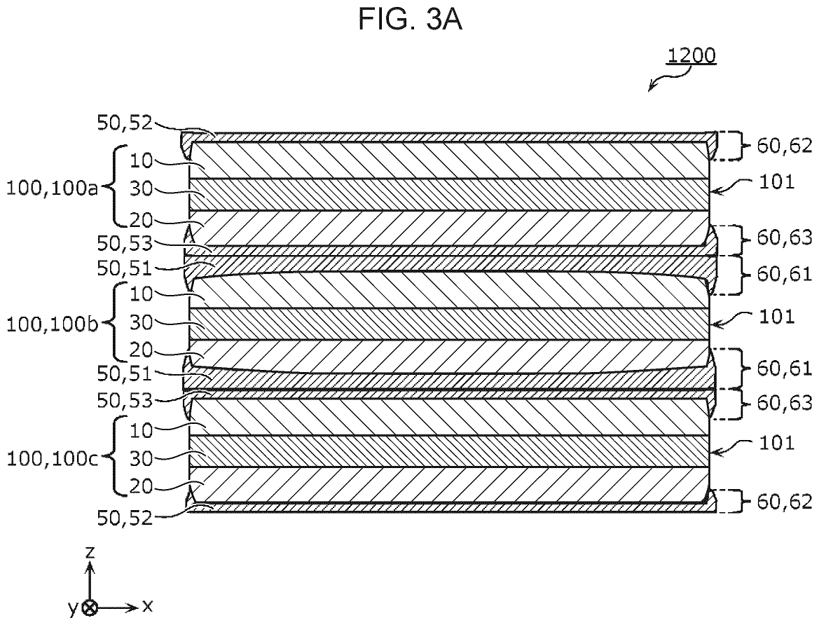

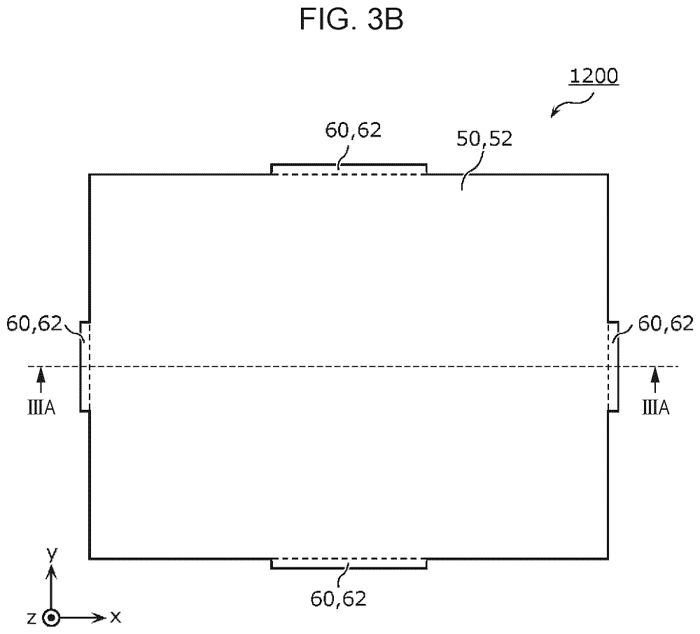

FIG. 3A is a sectional view of a battery 1200 according to the present modification. FIG. 3B is a plan view of the battery 1200 according to the present modification as seen from above in the z-axis direction. FIG. 3A illustrates a cross section taken along line IIIA-IIIA in FIG. 3B.

As illustrated in FIGS. 3A and 3B, the battery 1200 according to the present modification differs from the battery 1000 according to the embodiment in that the plurality of coverings 60 are not formed on the entire outer periphery of the unit cell 100 but are partially formed on central portions of the side surface 101 of the unit cell 100.

In the battery 1200, each covering 60 is formed so as to cover, in plan view of the side surface 101, a region including a central portion of the side surface 101 in a direction perpendicular to the laminating direction, and is not formed in a region including an end portion of the side surface 101 in the direction perpendicular to the laminating direction. Thus, the covering 60 binds the central portion of the side surface 101, where interlayer delamination tends to occur due to the effect of a bending stress on the battery 1200, and therefore interlayer delamination can be suppressed.

Moreover, a part of the end portion of the current collector 50 that is not continuous with the covering 60 is flush with the side surfaces 101 of the plurality of unit cells 100. Therefore, for example, when the side surface of the battery 1200 is to be protected from dust, gas, water, and the like by using an insulating resin or the like, it is easy to form another layer on the flush surface to have a shape and a thickness with high precision.

### Third Modification

Next, a third modification of the embodiment will be described.

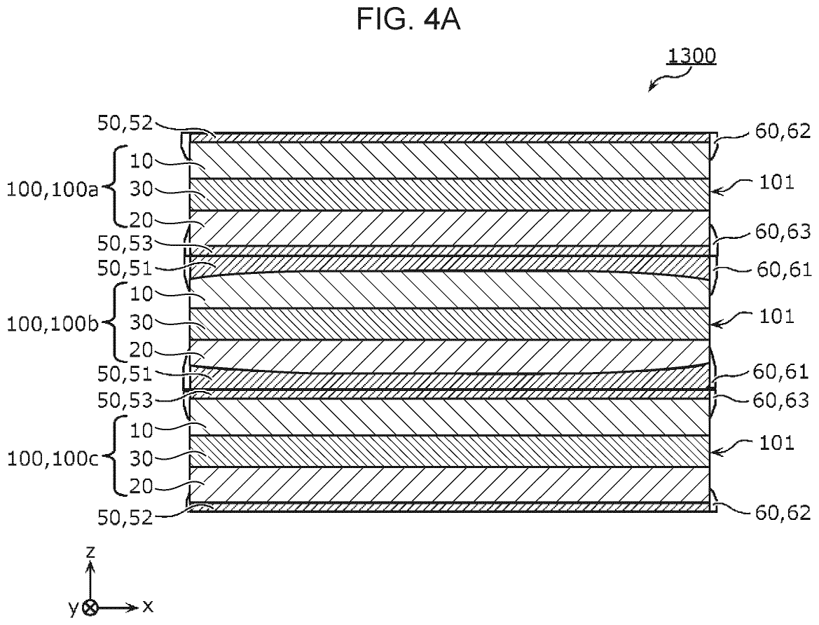

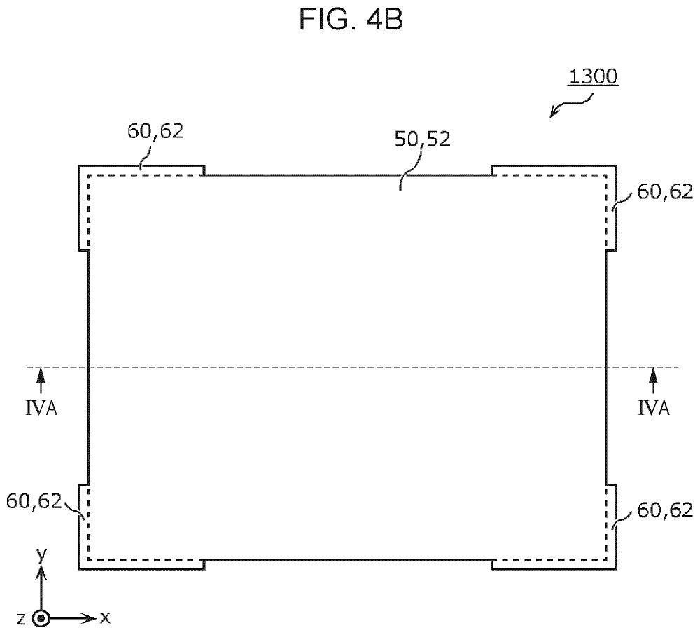

FIG. 4A is a sectional view of a battery 1300 according to the present modification. FIG. 4B is a plan view of the battery 1300 according to the present modification as seen from above in the z-axis direction. FIG. 4A illustrates a cross section taken along line IVA-IVA in FIG. 4B.

As illustrated in FIGS. 4A and 4B, the battery 1300 according to the present modification differs from the battery 1000 according to the embodiment in that the plurality of coverings 60 are not formed on the entire periphery of the unit cell 100 but are partially formed on end portions of the side surface 101 of the unit cell 100.

In the battery 1300, each covering 60 is formed so as to cover, in plan view of the side surface 101, a region including an end portion of the side surface 101 in a direction perpendicular to the laminating direction, and is not formed in a region including a central portion of the side surface 101 in the direction perpendicular to the laminating direction. Moreover, each covering 60 covers a corner (ridge) of the unit cell 100. Thus, since the covering 60 binds the corner of the unit cell 100, which tends to become the starting point of interlayer delamination, interlayer delamination at the corner of the unit cell 100, which tends to occur in a charge and discharge cycle and a thermal cycle, can be suppressed. Moreover, since the covering 60 protects the corner of the unit cell 100, which is fragile, impact resistance is also improved. Thus, it is possible to increase the reliability of the battery 1300.

Moreover, a part of the end portion of the current collector 50 that is not continuous with the covering 60 is flush with the side surfaces 101 of the plurality of unit cells 100. Therefore, for example, when the side surface of the battery 1300 is to be protected from dust, gas, water, and the like by using an insulating resin or the like, it is easy to form another layer on the flush surface to have a shape and a thickness with high precision.

### Forth Modification

Next, a fourth modification of the embodiment will be described.

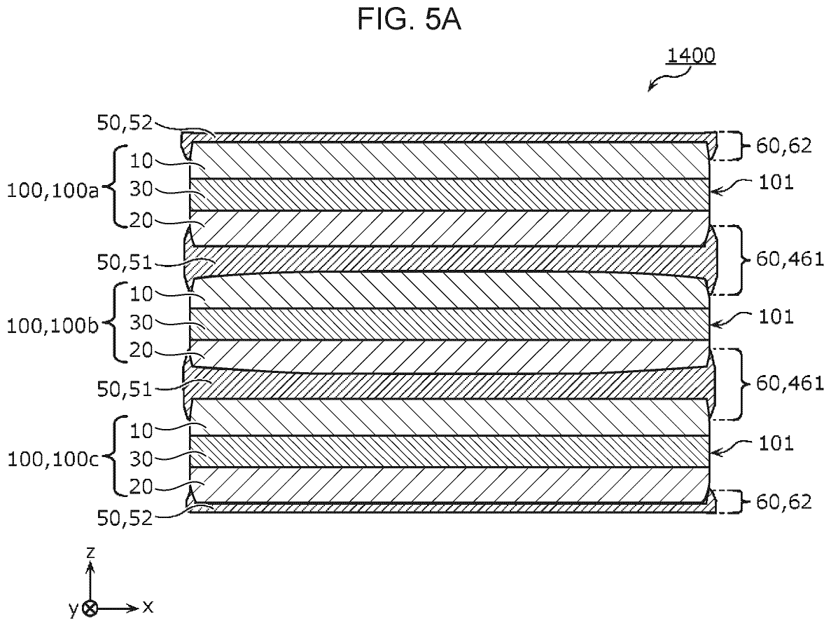

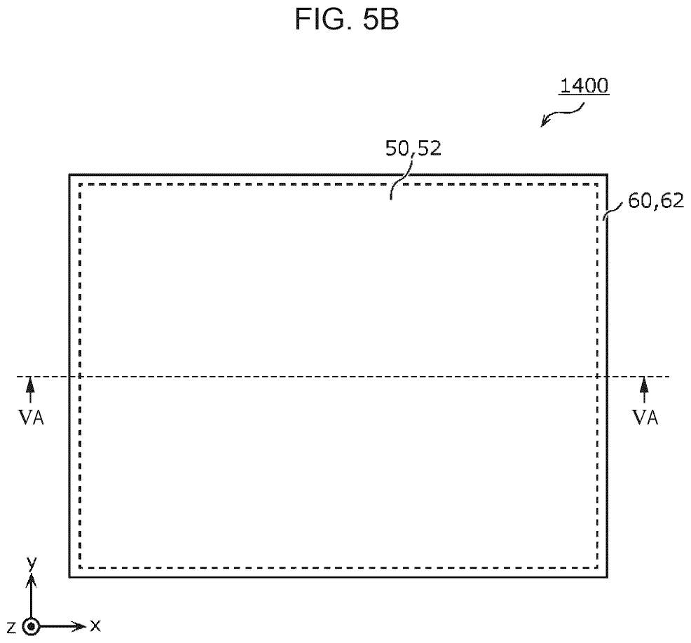

FIG. 5A is a sectional view of a battery 1400 according to the present modification. FIG. 5B is a plan view of the battery 1400 according to the present modification as seen from above in the z-axis direction. FIG. 5A illustrates a cross section taken along line VA-VA in FIG. 5B.

As illustrated in FIGS. 5A and 5B, the battery 1400 according to the present modification differs from the battery 1000 according to the embodiment in the following respects: the plurality of current collectors 50 do not include the inner current collector 53; and the plurality of coverings 60 do not include the inner covering 63 and include an inner covering 461 instead of the inner covering 61.

In the battery 1400, the plurality of current collectors 50 do not include the inner current collector 53 and include only the inner current collector 51 and the surface current collector 52, among the inner current collector 51, the inner current collector 53, and the surface current collector 52 of the battery 1000. Therefore, in the battery 1400, the inner current collector 53 is not disposed and only the inner current collector 51 is disposed between the adjacent unit cells 100, among the inner current collector 51 and the inner current collector 53 of the battery 1000. Also with such a configuration, since the inner current collector 51 is disposed between the adjacent unit cells 100, dissipation of heat from the central portion of the battery 1400 is promoted, and it is possible to increase the reliability of the battery 1400.

In the battery 1400, since the plurality of unit cells 100 are connected in series, the inner current collector 51 is a bipolar current collector on the upper and lower surfaces of which the first electrode layer 10 and the second electrode layer 20 of different polarities are laminated. If the plurality of unit cells 100 are connected in parallel, the first electrode layer 10 and the second electrode layer 20 having the same polarity are laminated on the upper and lower surfaces the inner current collector 51.

In the battery 1400, the plurality of coverings 60 include the inner covering 461 continuous with the inner current collector 51 and the surface covering 62 continuous with the surface current collector 52. The inner covering 461 is an example of a first covering. The inner covering 461 and the inner current collector 51 are integrally formed.

The inner covering 461 covers, among the plurality of unit cells 100, the side surfaces 101 of the unit cell 100a and the unit cell 100b adjacent to the inner current collector 51, or the side surfaces 101 of the unit cell 100b and the unit cell 100c. That is, the inner covering 461 extends in both of the upward and downward directions along the side surfaces 101 of two unit cells 100 that sandwich the inner current collector 51 from above and below, and covers a part of each of the two side surfaces 101.

In the battery 1400, each covering 60 covers the entire periphery of the side surface of the unit cell 100 in plan view. However, as in the battery 1200 or the battery 1300, each covering 60 may cover a part of the entire periphery.

### Fifth Modification

Next, a fifth modification of the embodiment will be described.

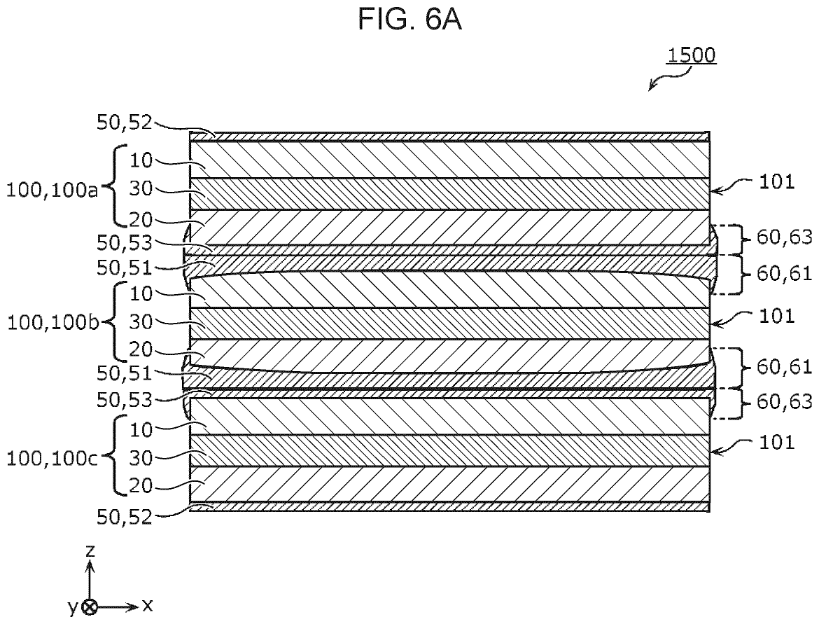

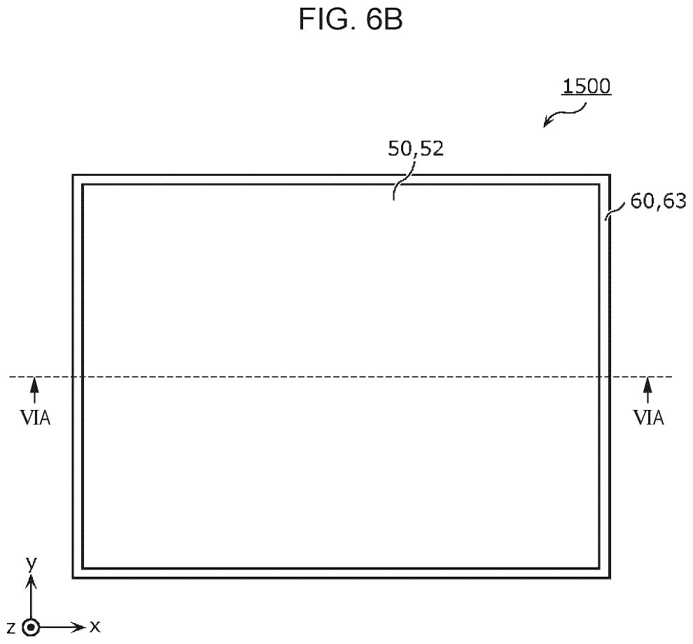

FIG. 6A is a sectional view of a battery 1500 according to the present modification. FIG. 6B is a plan view of the battery 1500 according to the present modification as seen from above in the z-axis direction. FIG. 6A illustrates a cross section taken along line VIA-VIA in FIG. 6B.

As illustrated in FIGS. 6A and 6B, the battery 1500 according to the present modification differs from the battery 1000 according to the embodiment in that the plurality of coverings 60 do not include the surface covering 62.

In the battery 1500, the plurality of coverings 60 do not include the surface covering 62 and include only the inner covering 61 and the inner covering 63, among the inner covering 61, the inner covering 63, and the surface covering 62 of the battery 1000. Also with such a configuration, dissipation of heat of a central portion of the battery 1500, which tends to have a high temperature, can be promoted by the inner covering 61 and the inner covering 63. Moreover, even when the thickness of each layer of the unit cell 100 is small, it is possible to suppress increase of short-circuit risk and to obtain the effect of improvement in heat dissipation performance.

In the battery 1500, the side surface (end surface) of the surface current collector 52 is exposed, and the side surface of the surface current collector 52 and the side surface of the unit cell 100 adjacent to the surface current collector 52 are flush with each other.

### Sixth Modification

Next, a sixth modification of the embodiment will be described.

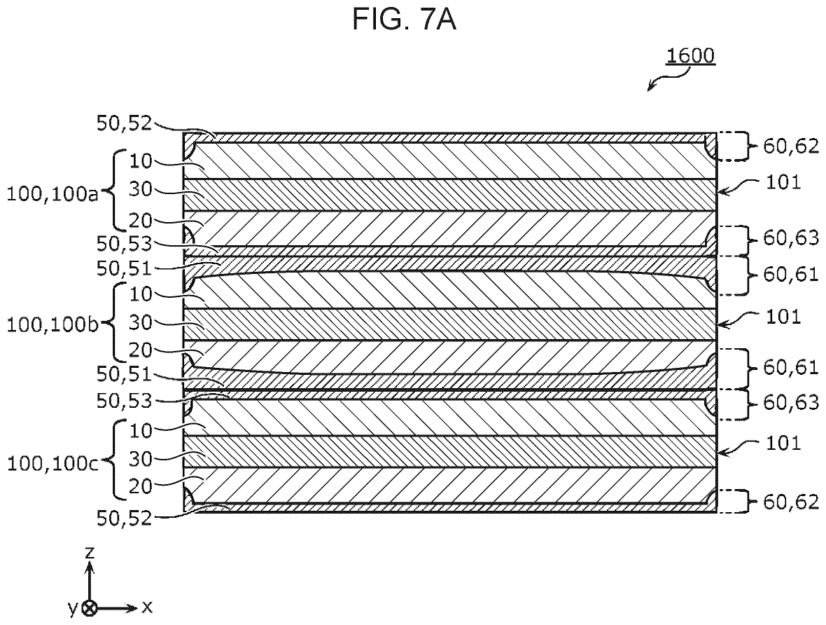

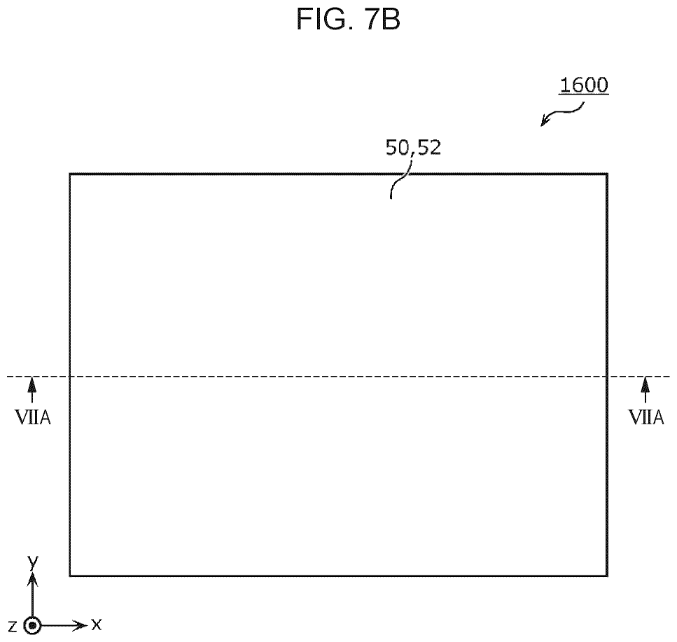

FIG. 7A is a sectional view of a battery 1600 according to the present modification. FIG. 7B is a plan view of the battery 1600 according to the present modification as seen from above in the z-axis direction. FIG. 7A illustrates a cross section taken along line VIIA-VIIA in FIG. 7B.

As illustrated in FIGS. 7A and 7B, the battery 1600 according to the present modification differs from the battery 1000 according to the embodiment in that the plurality of coverings 60 are formed so as to be completely embedded in the side surface 101.

In the battery 1600, each covering 60 is completely embedded in the side surface 101, and does not protrude beyond the side surface 101. In this way, by embedding the covering 60 in the side surface 101 so as not to protrude beyond the side surface 101, the bondability between the covering 60 and the side surface 101 is further improved, delamination of the current collector 50 and the unit cell 100 can be further suppressed, and the thermal shock resistance and the bending resistance of the covering 60 are improved. For example, the battery 1600 can be formed by pressing each covering 60 of the battery 1000 against the side surface 101.

Moreover, in the battery 1600, a surface, which is an exposed surface, of each of the plurality of coverings 60 that is not in contact with the side surface 101 and a portion of the side surface 101 of each of the plurality of unit cells 100 that is not in contact with the covering 60 are flush with each other, and constitute the flat side surface of the battery 1600. Thus, when an additional layer or the like is to be formed on the side surface of the battery 1600 in order to, for example, protect the side surface of the battery 1600 from dust, gas, water, and the like by using an insulating resin, it is easy to form the shape and the thickness with high precision (for example, by application, printing, or the like). Thus, it is possible to further increase the reliability of the battery 1600.

### Seventh Modification

Next, a seventh modification of the embodiment will be described.

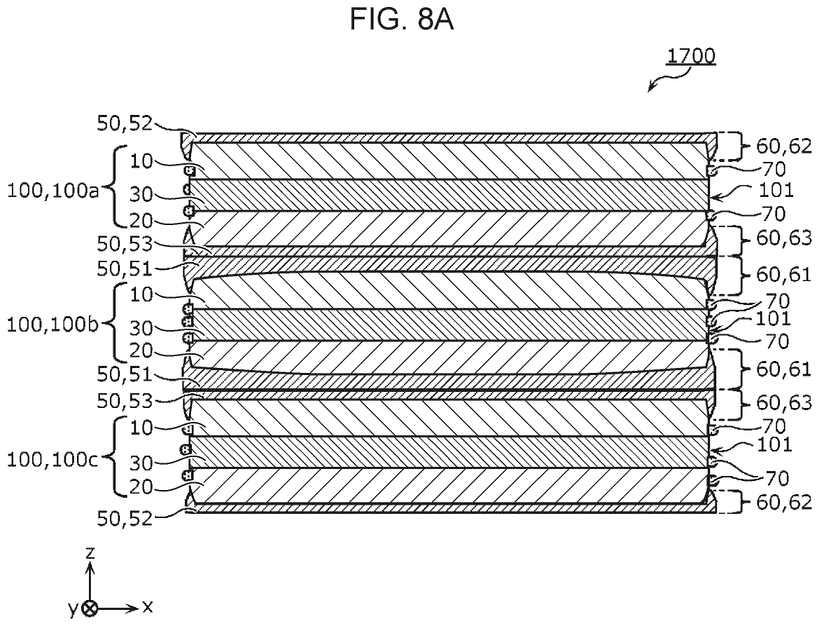

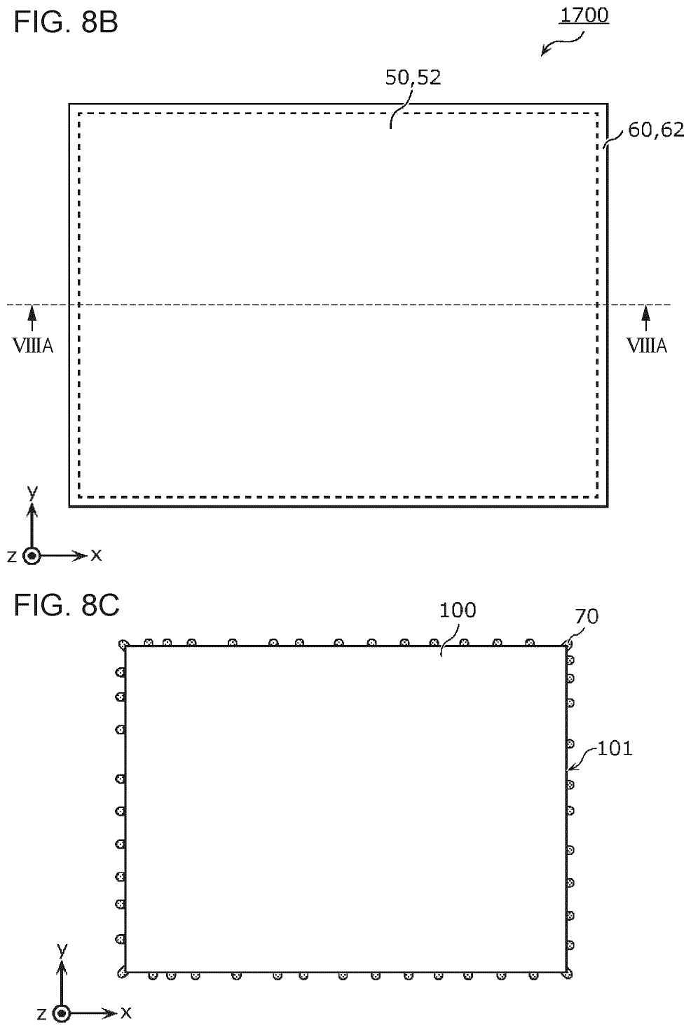

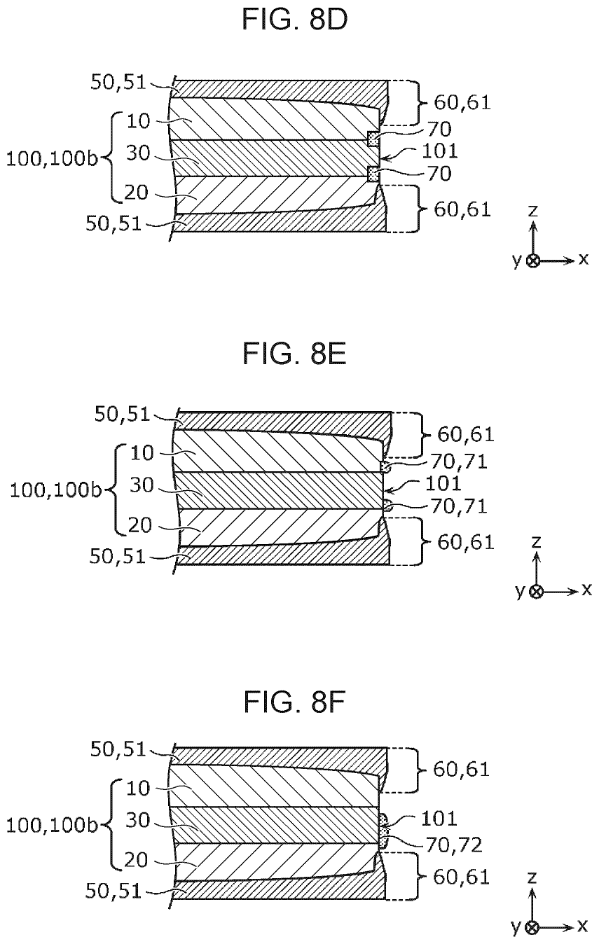

FIG. 8A is a sectional view of a battery 1700 according to the present modification. FIG. 8B is a plan view of the battery 1700 according to the present modification as seen from above in the z-axis direction. FIG. 8A illustrates a cross section taken along line VIIIA-VIIIA in FIG. 8B. FIG. 8C is a plan view illustrating an example of the arrangement of a plurality of coverings 70 according to the present modification. In FIG. 8C, in order to illustrate the arrangement of the plurality of coverings 70, illustration of members other than the unit cell 100 and the plurality of coverings 70 is omitted. In FIG. 8C, for ease of viewing, the plurality of coverings 70 are indicated by the same shading as in the cross section shown in FIG. 8A.

As illustrated in FIGS. 8A and 8B, the battery 1700 according to the present modification differs from the battery 1000 according to the embodiment in that the battery 1700 includes the plurality of island-like coverings 70. The coverings 70 are each an example of a third covering.

The plurality of coverings 70 are electroconductive members that cover the side surface 101 of each of the plurality of unit cells 100. The plurality of coverings 70 are not in contact with anything other than the side surface 101, and are isolated on the side surface 101. That is, the plurality of coverings 70 are not in contact with each other, and each of the plurality of coverings 70 is not in contact with the plurality of current collectors 50 and the plurality of coverings 60. Thus, each covering 70 is not electrically connected to any other electroconductive member on the side surface 101. It is sufficient that the plurality of coverings 70 cover the side surface 101 of at least one unit cell 100 among the plurality of unit cells 100. For example, the plurality of coverings 70 may cover the side surface 101 of only the unit cell 100b among the plurality of unit cells 100. The number of the covering 70 included in the battery 1700 may be one.

As illustrated in FIG. 8C, the plurality of coverings 70 include a covering 70 that covers a corner of the unit cell 100. The corner of the unit cell 100 can be said to be a ridge of the unit cell 100, as described above. Thus, since the covering 70 protects the corner of the unit cell 100, which is fragile, impact resistance is improved. Among the plurality of coverings 70, the covering 70 that covers the corner may have the largest coverage area on the side surface 101. Thus, since the covering 70 binds the corner of the unit cell 100, which tends to become the starting point of interlayer delamination due to repeated charging and discharging and thermal cycle, interlayer delamination can be suppressed. The covering 70 that covers the corner may have a coverage area on the side surface 101 that is less than or equal that of another covering 70. The plurality of coverings 70 need not include the covering 70 that covers the corner of the unit cell 100.

It is sufficient that the plurality of coverings 70 be each made of an electroconductive material such as a metal, and the material is not particularly limited. The plurality of coverings 70 each include, for example, a metal. The plurality of coverings 70 are made of, for example, stainless steel, nickel, aluminum, iron, titanium, copper, palladium, gold, platinum, or an alloy of two or more of these. The plurality of coverings 70 may include coverings 70 that are made of materials that differ from each other. The plurality of coverings 70 are each made of, for example, the same material as one of the current collectors 50 among the plurality of current collectors 50.

Since the battery 1700 includes the plurality of coverings 70 and the coverings 70 are isolated on the side surface 101, it is possible to increase the heat dissipation performance of the battery 1700 at the side surface 101 without affecting the battery characteristics. Thus, heat dissipation of the battery 1700 is promoted, and it is possible to increase the reliability of the battery 1700.

The plurality of coverings 70 may include a covering 70 at least a part of which is embedded in the side surface 101 of the unit cell 100. Thus, the bondability between the covering 70 and the side surface 101 is improved, and the thermal shock resistance and the bending resistance of the covering 70 are improved.

The plurality of coverings 70 may include a covering 70 that is completely embedded in the side surface 101. FIG. 8D is a partial sectional view illustrating the covering 70 that is completely embedded in the side surface 101. FIG. 8D illustrates a cross section of the unit cell 100b in the vicinity of the side surface 101. Referring to FIG. 8D, only the covering 70 that covers the side surface 101 of the unit cell 100b will be described. However, a similar description applies to the coverings 70 that cover the side surfaces 101 of the other the unit cells 100a and 100c.

As illustrated in FIG. 8D, the plurality of coverings 70 may include a covering 70 that is completely embedded in the side surface 101 and does not protrude beyond the side surface 101. All of the coverings 70 of the battery 1700 may be the coverings 70 illustrated in FIG. 8D. In this way, by embedding the covering 70 in the side surface 101 so as not to protrude beyond the side surface 101, the bondability between the covering 70 and the side surface 101 is improved, and the thermal shock resistance and the bending resistance of the covering 70 are improved. For example, by pressing the covering 70 against the side surface 101, the covering 70 is prevented from protruding beyond the side surface 101.

In the example illustrated in FIG. 8D, a surface, which is an exposed surface, of the covering 70, which is embedded in the side surface 101, that is not in contact with the side surface 101 and a portion of the side surface 101 that is not in contact with the covering 70 are flush with each other. That is, an end portion of the unit cell 100 is a flat surface. Thus, when an additional layer or the like is to be formed from an insulating resin or the like on the side surface 101 in order to, for example, protect the side surface 101 from dust, gas, water, and the like, it is easy to form the shape and the thickness with high precision (by application, printing, or the like).

In each covering 70, a portion of the covering 70 adjacent to the side surface 101 of the unit cell 100 may have higher crystallinity than a portion, which is an exposed portion, of the covering 70 opposite from the side surface 101. Thus, the thermal resistance of the portion the covering 70 adjacent to the unit cell 100 is reduced, and the heat dissipation performance of the battery 1700 is improved. The adjustment and the evaluation of the crystallinity of a metal included in the covering 70 can be performed by using a method similar to the aforementioned method of adjusting and evaluating the crystallinity of a metal included the current collector 50 and the covering 60.

Among the plurality of coverings 70, a covering 70 that is nearer to a central portion of the battery 1700 in the laminating direction may have higher crystallinity. Thus, it is possible to further promote dissipation of heat of the central portion of the battery 1700, which tends to have a high temperature.

The plurality of coverings 70 are formed, for example, by applying an electroconductive resin by using a dispenser or screen printing or by thermally spraying a metal through a metal mask to cause the resin or the metal to adhere to the side surface 101 in predetermined shape such as a circle, an ellipse, or a rectangle. As with the covering 60, the covering 70 that has been formed may be brushed, polished, or rubbed. When the covering 60 is being formed, the plurality of coverings 70 may be formed by separating parts of the covering 60 from the covering 60 and causing the parts to adhere to the side surface 101.

In plan view of the side surface 101, the area of each covering 70 may be, for example, smaller than the area of each covering 60. The length of each covering 70 in the laminating direction is smaller than the thickness of the solid electrolyte layer 30.

The plurality of coverings 70 may include coverings 70 whose sizes differ from each other. FIGS. 8E and 8F are partial sectional views illustrating the sizes of the coverings 70. FIGS. 8E and 8F each illustrate a cross section in the vicinity of the side surface 101 of the unit cell 100b. Referring to FIGS. 8E and 8F, only the coverings 70 that cover the side surface 101 of the unit cell 100b will be described. However, a similar description applies to the coverings 70 that cover the side surfaces 101 of the other unit cells 100a and 100c.

As illustrated in FIGS. 8E and 8F, the plurality of coverings 70 may include a covering 71 and a covering 72 whose coverage areas on the side surface 101 differ from each other. The coverage area of the covering 72 is larger than the coverage area of the covering 71. The length of the covering 72 in the laminating direction is larger than the length of the covering 71 in the laminating direction. The covering 72 covers, for example, the side surface 101 from the solid electrolyte layer 30 to the first electrode layer 10 or to the second electrode layer 20. The covering 72 may have a greater length on the side surface 101 in a direction perpendicular to the laminating direction than the covering 71, and thus may have a larger coverage area than the covering 71.

The covering 72 has, for example, the largest coverage area on the side surface 101 among the plurality of coverings 70. The covering 71 has, for example, the smallest coverage area on the side surface 101 among the plurality of coverings 70.

For example, in the battery 1700, in plan view of the side surface 101, in a direction perpendicular to the laminating direction, the covering 72 is positioned on an end portion of the side surface 101 and/or in the vicinity of the end portion, and the covering 71 is positioned on a central portion of the side surface 101 and/or in the vicinity of the central portion. In this way, among the plurality of coverings 70, a covering 70 that is nearer to an end portion of the side surface 101 in a direction perpendicular to the laminating direction may have a larger coverage area on the side surface 101. Thus, the coverage area of the covering 70 near an end portion of the side surface 101, which tends to become the starting point of interlayer delamination due to repeated charging and discharging and thermal cycle, is large, and therefore interlayer delamination can be suppressed. The covering 72 may be disposed so as to cover a corner (ridge) of the unit cell 100.

For example, in the battery 1700, in plan view of the side surface 101, in a direction perpendicular to the laminating direction, the covering 72 is positioned on a central portion of the side surface 101 and/or in the vicinity of the central portion, and the covering 71 is positioned on an end portion of the side surface 101 and/or in the vicinity of the end portion. In this way, among the plurality of coverings 70, a covering 70 that is nearer to the central portion of the side surface 101 in a direction perpendicular to the laminating direction may have a larger coverage area on the side surface 101. Thus, the coverage area of the covering 70 on the central portion of the side surface 101, where interlayer delamination tends to occur due to the effect of a bending stress on the battery 1700, and therefore interlayer delamination can be suppressed. In particular, such a configuration is effective when the battery 1700 is a large battery, in which the bending stress tends to large.

The battery 1700 has a configuration such that the battery 1000 according to the embodiment further includes the plurality of coverings 70. However, this is not a limitation, and a battery according to each modification may further include at least one covering 70.

### Eighth Modification

Next, an eighth modification of the embodiment will be described.

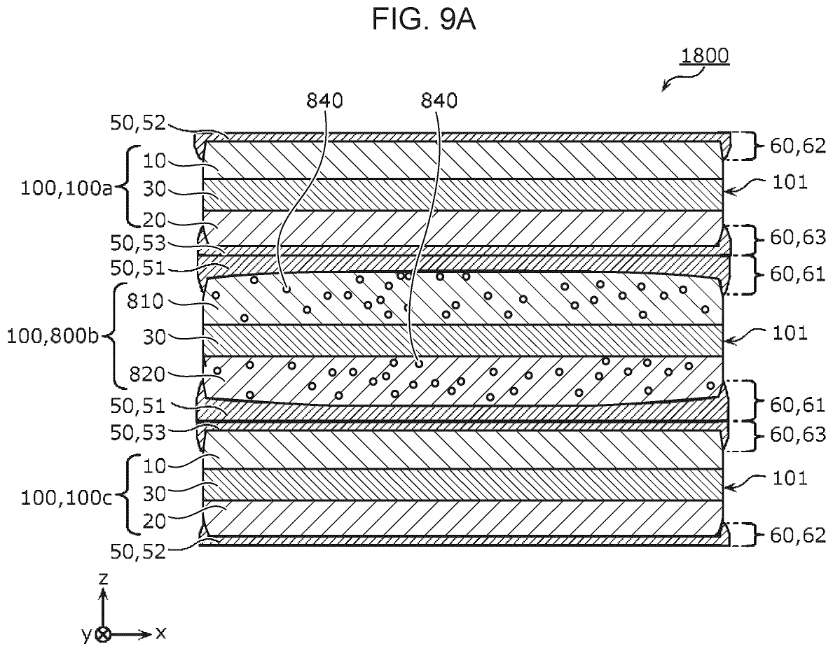

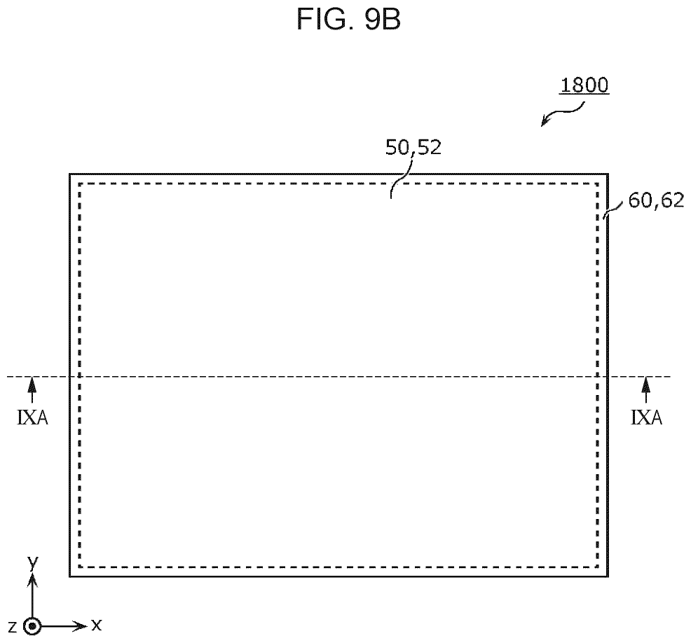

FIG. 9A is a sectional view of a battery 1800 according to the present modification. FIG. 9B is a plan view of the battery 1800 according to the present modification as seen from above in the z-axis direction. FIG. 9A illustrates a cross section taken along line IXA-IXA in FIG. 9B.

As illustrated in FIGS. 9A and 9B, the battery 1800 according to the present modification differs from the battery 1000 according to the embodiment in that the plurality of unit cells 100 include a unit cell 800b instead of the unit cell 100b. The unit cell 800b is an example of a first unit cell.

The unit cell 800b includes a first electrode layer 810 and a second electrode layer 820, instead of the first electrode layer 10 and the second electrode layer 20 of the unit cell 100b. The first electrode layer 810 and the second electrode layer 820 are electrode layers that are adjacent to the inner current collectors 51.

The first electrode layer 810 and the second electrode layer 820 are thicker than the first electrode layer 10 of the unit cell 100a and the second electrode layer 20 of the unit cell 100c, which are electrode layers adjacent to the surface current collectors 52. Thus, the stress of thermal expansion of the inner current collector 51, which tends to thermally expand, is easily absorbed by the first electrode layer 810 and the second electrode layer 820 that are thick. Therefore, although delamination tends to occur at the interfaces between the unit cell 800b and the inner current collectors 51 that is thicker than the surface current collector 52, the stress is absorbed by the first electrode layer 810 and the second electrode layer 820 that are thick, and the delamination is suppressed and the thermal shock resistance is improved. Since the side surfaces of the first electrode layer 810 and the second electrode layer 820 are large and it is possible to increase the size of the covering 60, it is possible to further improve the heat dissipation performance. The thickness of the first electrode layer 810 is, for example, greater than or equal to 101% and less than or equal to 120% of the thickness of the first electrode layer 10 of the unit cell 100a. The thickness of the second electrode layer 820 is, for example, greater than or equal to 101% and less than or equal to 120% of the thickness of the second electrode layer 20 of the unit cell 100c. If the thickness of each of the electrolyte layers is not uniform, the thickness is an average thickness.

The first electrode layer 810 and the second electrode layer 820 include more pores 840 than the first electrode layer 10 of the unit cell 100a and the second electrode layer 20 of the unit cell 100c. With such a configuration, the thermal capacity and the heat generation density of an electrode layer in a central portion of the battery 1800, which tends to have a high temperature, are reduced. Moreover, the pores 840 can be easily exposed on the side surface 101, and the bondability between the covering 60 and the side surface 101 is improved due to an anchoring effect as the covering 60 enters into the pores 840. Thus, the reliability of the battery 1800 is increased. Although illustration is omitted, the first electrode layer 10 and the second electrode layer 20 of the unit cells 100a and 100c may also include the pores 840.

The volume percentage of the pores 840 in the first electrode layer 810 and in the second electrode layer 820 is, for example, greater than or equal to 10% and less than or equal to 40%. The volume percentage of the pores 840 in the first electrode layer 810 and in the second electrode layer 820 may be, for example, greater than or equal to 10% and less than or equal to 20% or may be greater than or equal to 20% and less than or equal to 40%. The volume percentage of the pores 840 in the first electrode layer 10 of the unit cell 100a and in the second electrode layer 20 of the unit cell 100c is, for example, greater than or equal to 0% and less than or equal to 10%.

The volume of the pores 840 in the first electrode layer 810 may be adjusted so that the volume of the first electrode layer 810, which is large due to the large thickness, becomes the same as the volume of the first electrode layer 10 of the unit cell 100a. Likewise, the volume of the pores 840 in the second electrode layer 820 may be adjusted so that the volume of the second electrode layer 820, which is large due to the large thickness, becomes the same as the volume of the second electrode layer 20 of the unit cell 100c. That is, the thicknesses of the first electrode layer 810 and the second electrode layer 820 and the volume of the pores 840 may be controlled so that the design volumes of the three unit cells 100a, 800b, and 100c become substantially the same as each other.

The thicknesses of the first electrode layer 810 and the second electrode layer 820 and the volume of the pores 840 can be adjusted by changing the drying profile, the amount of a volatile solvent included in slurry, the pressure in a pressing operation, and the like in printing and application of an active material. By making the amount of an active material to be used for the first electrode layer 810 and the second electrode layer 820 of the unit cell 800b be the same as the amount of the active material to be used for the first electrode layer 10 and the second electrode layer 20 of the unit cells 100a and 100c, it is possible to perform control so that the design volumes of the three unit cells 100a, 800b, and 100c become substantially the same as each other.

In the battery 1800, the number of the unit cells 100 may be two. In this case, among the first electrode layer 10 and the second electrode layer 20 of one unit cell 100, the first electrode layer 10 or the second electrode layer 20 near the center of the battery 1800 and adjacent to the inner current collector 51 is replaced with the first electrode layer 810 or the second electrode layer 820. That is, the first electrode layer 810 and the second electrode layer 820 need not be included in the same unit cell 100, and a pair of electrode layers of the same unit cell 100 may have different thicknesses and may include different volumes of the pores 840.

The battery 1800 has a configuration such that the first electrode layer 10 and the second electrode layer 20 of the unit cell 100b of the battery 1000 according to the embodiment are replaced with the first electrode layer 810 and the second electrode layer 820. However, this is not a limitation, and the first electrode layer 10 and the second electrode layer 20 of the unit cell 100b of a battery according to each modification may be replaced with the first electrode layer 810 and the second electrode layer 820.

### Ninth Modification

Next, a ninth modification of the embodiment will be described.

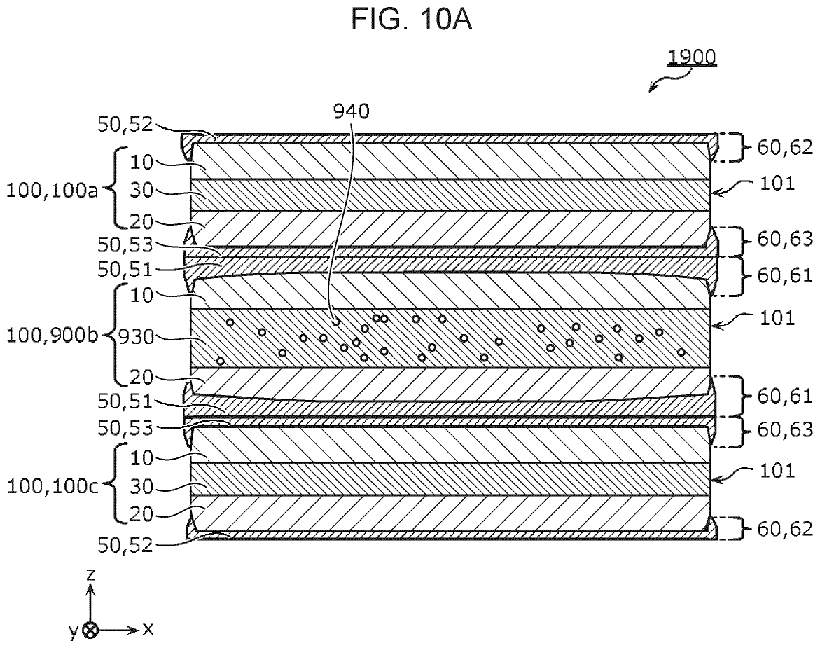

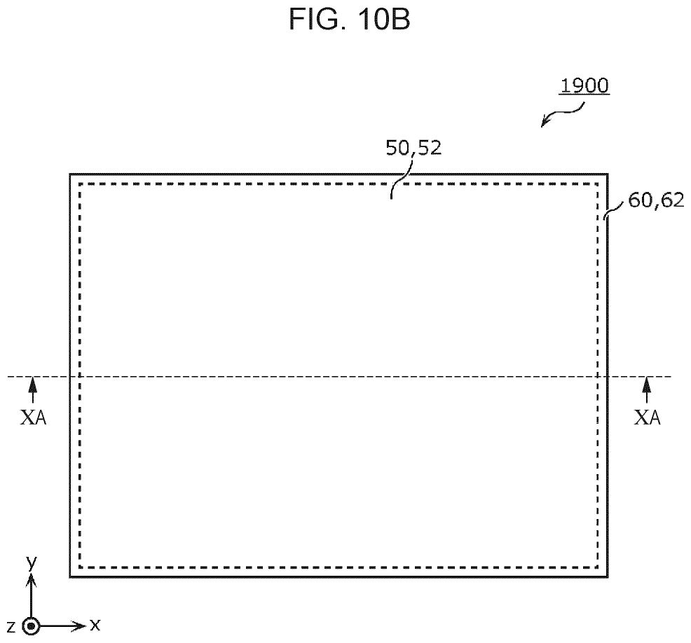

FIG. 10A is a sectional view of a battery 1900 according to the present modification. FIG. 10B is a plan view of the battery 1900 according to the present modification as seen from above in the z-axis direction. FIG. 10A illustrates a cross section taken along line XA-XA in FIG. 10B.

As illustrated in FIGS. 10A and 10B, the battery 1900 according to the present modification differs from the battery 1000 according to the embodiment in that the plurality of unit cells 100 include a unit cell 900b instead of the unit cell 100b. The unit cell 900b is an example of a first unit cell.

The unit cell 900b is positioned between the unit cell 100a and the unit cell 100c, which are positioned at both ends in the laminating direction among the plurality of unit cells 100. The unit cell 900b is adjacent to the inner current collector 51. The unit cell 900b includes a solid electrolyte layer 930 instead of the solid electrolyte layer 30 of the unit cell 100b.

The solid electrolyte layer 930 is thicker than the solid electrolyte layers 30 of the unit cells 100a and 100c. Thus, the stress of thermal expansion of the inner current collector 51, which tends to thermally expand, is easily absorbed by the elasticity of the solid electrolyte layer 930 that is thick. Therefore, although the effect of thermal expansion is particularly large on the inner current collector 51 that is thicker than the surface current collector 52 and delamination tends to occur at the interface between the inner current collector 51 and the unit cell 900b, the stress is absorbed by the solid electrolyte layer 930 that is thick, and the delamination is suppressed and the thermal shock resistance is improved. The thickness of the solid electrolyte layer 930 is greater than or equal to 101% and less than or equal to 120% of the thickness of the solid electrolyte layer 30 of each of the unit cells 100a and 100c. If the thickness of each of the solid electrolyte layers 30 and 930 is not uniform, the thickness is an average thickness.

The solid electrolyte layer 930 includes more pores 940 than the solid electrolyte layers 30 of the unit cells 100a and 100c. With such a configuration, the stress of thermal expansion of the inner current collector 51 in a central portion of the battery 1900, which tends to have a high temperature, can be easily absorbed, and a structural defect such as interfacial delamination that tends to occur around the inner current collector 51 can be suppressed. Moreover, the thermal capacity of the solid electrolyte layer 930 is reduced, and increase of temperature due to a battery operation is suppressed. Although illustration is omitted, the solid electrolyte layers 30 of the unit cells 100a and 100c may also include the pores 840.

The volume percentage of the pores 940 in the solid electrolyte layer 930 is, for example, greater than or equal to 10% and less than or equal to 40%. The volume percentage of the pores 940 in the solid electrolyte layer 930 may be, for example, greater than or equal to 10% and less than or equal to 20% or may be greater than or equal to 20% and less than or equal to 40%. The volume percentage of the pores 940 in the solid electrolyte layers 30 of the unit cells 100a and 100c is, for example, greater than or equal to 0% and less than or equal to 10%.

The volume of the pores 940 in the solid electrolyte layer 930 can be adjusted by changing the drying profile, the amount of a solvent, the pressure in a pressing operation, and the like in printing and application of an active material.

The battery 1900 has a configuration such that the solid electrolyte layer 30 of the unit cell 100b of the battery 1000 according to the embodiment is replaced with the solid electrolyte layer 930. However, this is not a limitation, and the solid electrolyte layer 30 of the unit cell 100b according to each modification may be replaced with the solid electrolyte layer 930.

### Tenth Modification

Next, a tenth first modification of the embodiment will be described.

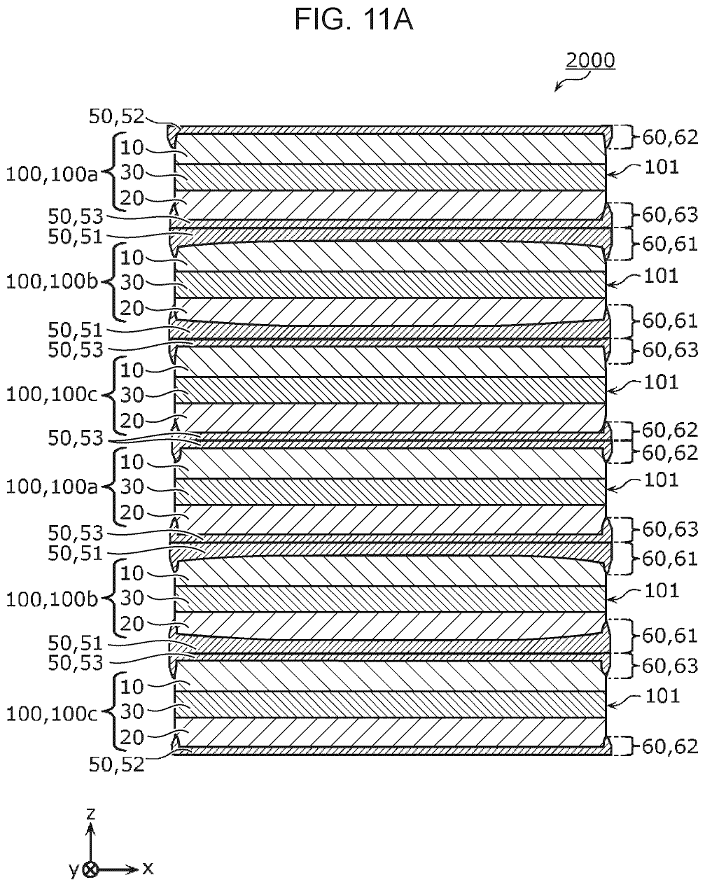

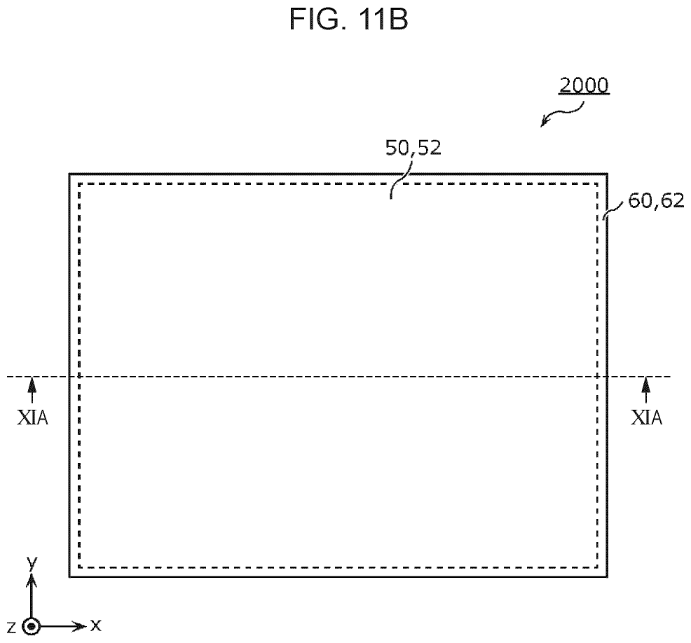

FIG. 11A is a sectional view of a battery 2000 according to the present modification. FIG. 11B is a plan view of the battery 2000 according to the present modification as seen from above in the z-axis direction. FIG. 11A illustrates a cross section taken along line XIA-XIA in FIG. 11B.

As illustrated in FIGS. 11A and 11B, the battery 2000 according to the present modification differs from the battery 1000 according to the embodiment in that the number of unit cells 100 included in the plurality of unit cells 100 is larger.

The battery 2000 is formed, for example, by laminating two batteries 1000.

Therefore, in the battery 2000, the current collector 50 between the unit cell 100a and the unit cell 100c, which become adjacent to each other when the batteries 1000 are laminated, is the inner current collector 53. The battery 2000 may include the inner current collector 51 instead of the inner current collector 53. Although two batteries 1000 are laminated so as to be connected in series in the battery 2000, the batteries 1000 may be laminated so as to be connected in parallel. In this way, since the battery 2000 includes a large number of unit cells 100 and includes the inner current collector 51 as in the battery 1000, it is possible to realize the battery 2000 having high reliability and a high voltage or a high capacity.

The battery 2000 may be formed by forming batteries 1000 and then laminating the batteries 1000, or may be formed by preparing a laminated body including six unit cells 100 and then staking the laminated bodies. The battery 2000 may be a battery in which three or more batteries 1000 are laminated.

The battery 2000 has a configuration such that the batteries 1000 according to the embodiment are laminated. However, a battery may have a configuration such that batteries according to each modification are laminated or two or more batteries according to the embodiment and each modification are laminated in combination.

### Method of Manufacturing Battery

Next, an example of a method of manufacturing a battery according to the present embodiment will be described. Hereafter, a method of manufacturing the battery 1000 according to the embodiment will be described. A battery according to each modification of the embodiment can be manufactured by appropriately using the method of manufacturing the battery 1000. The manufacturing method described below is an example, and a method of manufacturing a battery according to the embodiment or each of the modifications is not limited to the following example.

In the following description, a case where the first electrode layer 10 is a positive electrode layer and the second electrode layer 20 is a negative electrode layer will be described.

First, pastes for forming the first electrode layer 10 and the second electrode layer 20 by printing are made. As a solid electrolyte material used for a mixture for each of the first electrode layer 10 and the second electrode layer 20, for example, grass power of Li₂S-P₂Ss-based sulfide having an average particle diameter of about 2 μm and including a triclinic-system crystal as a main component is prepared. As the glass powder, for example, glass powder having high ion conductivity of about 3×10⁻³S/cm to 4×10⁻³ S/cm can be used. As a positive-electrode active material, for example, powder of Li·Ni·Co·Al composite oxide (LiNi_{0.8}Co_{0.15}Al_{0.05}O₂) having an average particle diameter of about 3 μm and having a layered structure is used. A paste for the first electrode layer 10 is made by dispersing a mixture including the positive-electrode active material and the glass powder in an organic solvent or the like. As a negative-electrode active material, for example, natural graphite powder having an average particle diameter of about 4 μm is used. A paste for the second electrode layer 20 is made in a similar manner by dispersing the negative-electrode active material and the glass powder in an organic solvent or the like.

Next, as materials to be used as the plurality of current collectors 50, for example, an Al foil and a Cu foil having a thickness of about 20 μm are prepared. By using a screen printing method, the paste for the first electrode layer 10 is printed on one surface of the Al foil and the paste for the second electrode layer 20 is printed on one surface of the Cu foil to each have a predetermined shape with a thickness greater than or equal to about 50 μm and less than or equal to about 100 μm. The paste for the first electrode layer 10 and the paste for the second electrode layer 20 are dried at a temperature higher than equal to 80° C. and lower than or equal to 130° C. to each have a thickness greater than or equal to 30 μm and less than or equal to 60 μm. Thus, the plurality of current collectors 50 (Al foils and Cu foils) on each of which the first electrode layer 10 and the second electrode layer 20 are formed are obtained. As each of the current collectors 50 for forming the first electrode layer 10 and the second electrode layer 20 of the unit cell 100b thereon, a current collector 50 whose outer shape is larger than that of other current collectors 50 by 1 μm or greater and 5 μm or less and whose thickness is larger than that of other current collectors 50 by 0.1 μm or greater and 3 μm or less is used. Crystallinity is checked by XRD, and, as each of the current collectors 50 for forming the first electrode layer 10 and the second electrode layer 20 of the unit cell 100b thereon, a current collector 50 having higher crystallinity than the other current collectors 50 is selected and used. Since the crystallinity can be improved by heat treatment, the current collector 50 is heat treated as necessary. In order to thicken an end portion of the current collector 50, by using a curved die, the current collector 50 is pressed in nitrogen at a temperature higher than or equal to 40° C. and lower than or equal to 60° C. with a pressure higher than or equal to 20 kg/cm² and lower than or equal to 60 kg/cm². As the curved die, for example, a die that can make an end portion of the current collector 50 thicker than a central portion of the current collector 50 by 1% or more and 10% or less is used.

Next, a paste for the solid electrolyte layer 30, in which the glass powder is dispersed in an organic solvent, is made. On a surface of each of the first electrode layer 10 and the second electrode layer 20, by using a metal mask, the paste for the solid electrolyte layer 30 is printed, for example, with a thickness of about 100 μm. Subsequently, the first electrode layer 10 and the second electrode layer 20, on each of which the paste for the solid electrolyte layer 30 is printed, are dried at a temperature higher than or equal to 80° C. and lower than or equal to 130° C.

Next, the solid electrolyte printed on the first electrode layer 10 and the solid electrolyte printed on the second electrode layer 20 are laminated so as to be in contact with each other and to face each other. Thus, a laminated body in which the unit cell 100 is sandwiched between two current collectors 50 is obtained.

Next, between a compression die plate and a surface of the current collector 50, an clastic material sheet having a thickness greater than or equal to 50 μm and less than or equal to 100 μm and having an elastic modulus of about 5×10⁶ Pa is inserted. With this configuration, a pressure is applied to the laminated body via the elastic material sheet. A surface of the elastic sheet to be in contact with the plate-shaped member may have been embossed to have a surface roughness Rz that is greater than or equal to about 1 μm and less than or equal to about 10 μm. Subsequently, a pressure higher than or equal to 300 MPa and lower than or equal to 350 MPa is applied for about 90 seconds by using the compression die plate while heating the compression die plate at a temperature higher than or equal to 50° C. and lower than or equal to 80° C.

Laminated bodies, each of which obtained as described above and in each of which the unit cell 100 is sandwiched between the two current collectors 50, are laminated so as to be connected in series or in parallel. In the battery 1000, three laminated bodies are laminated so as to be connected in series. Thus, it is possible to realize a laminated battery having a high voltage or a high capacity. For example, a thermosetting conductor paste including Ag particles, as an electroconductive resin material, is screen printed onto the main surface of the current collector 50 of the laminated body with a thickness greater than or equal to about 1 μm and less than or equal to about 5 μm, and another laminated body is placed on the laminated body so as to be connected in series, and the laminated bodies are press-bonded with a pressure of about 10 kg/cm². To increase the number of serial connections, the same process is repeated for the number of unit cells 100. Subsequently, for example, while applying a pressure of about 1 kg/cm² and immobilizing the laminated bodies, heat-curing treatment is performed at a temperature higher than or quail to 100° C. and lower than or equal to 130° C. for a time longer than or equal to 40 minutes and shorter than or equal to 100 minutes, and then the laminated bodies are gradually cooled to the room temperature. Next, by using a nylon brush whose bristle diameter ϕ is 100 μm, a side surface of the current collector 50 is brushed while avoiding breakage of the unit cell 100 to deform the current collector 50 protruding beyond the side surface 101 of the unit cell 100, thereby forming the covering 60 in close contact with the side surface 101. In this way, the battery 1000 in which multiple unit cells 100 are laminated can be obtained.

As the electroconductive resin material, various materials having various curing temperatures and including various conductor particles can be used. For example, when a thin applied film is to be formed, smaller particles or scale-shaped particles may be used as conductor particles such as Ag particles. In order to form an alloy together with the current collector 50 at the curing temperature, a low-melting point metal may be included.

A method of forming the battery 1000 and the order of steps are not limited to those of the example described above.

In the manufacturing method described above, an example in which a paste for the second electrode layer 20, a paste for the first electrode layer 10, a paste for the solid electrolyte layer 30, and a conductor paste are applied by printing is described. However, this is not a limitation. As the application method, for example, a doctor blade method, a calendar method, a spin coating method, a dip coating method, an inkjet method, an offset method, a die coating method, a spraying method, or the like may be used.

In the manufacturing method described above, a thermosetting conductor paste including metal particles of silver is described as an example of the conductor paste, but the conductor paste is not limited to this. As the conductor paste, a thermosetting conductor paste including high-melting-point (for example, higher than or equal to 400° C.) highly-conductive metal particles, low-melting-point metal particles (whose melting point is, desirably, lower than the curing temperature of the conductor paste, for example, lower than or equal to 300° C.), and a resin may be used. Examples of the material of the high-melting-point highly-conductive metal particles include silver, copper, nickel, zinc, aluminum, palladium, gold, platinum, and an alloy of a combination of any of these. Examples of the material of metal particles whose melting point is lower than or equal to 300° C. include tin, a tin-zinc alloy, a tin-silver alloy, a tin-copper alloy, a tin-aluminum alloy, a tin-lead alloy, indium, an indium-silver alloy, an indium-zinc alloy, an indium-tin alloy, bismuth, a bismuth-silver alloy, a bismuth-nickel alloy, a bismuth-tin alloy, a bismuth-zinc alloy, and a bismuth-lead alloy. When a conductor paste including such low-melting-point metal particles is used, even at a curing temperature that is lower than the melting point of the high-melting-point highly-electroconductive metal particles, solid-phase and liquid-phase reactions proceed in a contact portion between the metal particles in the conductor paste and a metal included in the current collector. Thus, at the interface between the conductor paste and the surface of the current collector, a diffusion region alloyed by the solid-phase and liquid-phase reactions is formed around the contact portion. An example of the formed alloy is a silver-copper-based alloy, which is a highly electroconductive alloy, when silver or a silver alloy is used for the electroconductive metal particles and copper is used for the current collector. Moreover, depending on the combination of the electroconductive metal particles and the current collector, a silver-nickel alloy, a silver-palladium alloy, or the like may be formed. With this configuration, the electroconductive resin material and the current collector 50 are more strongly bonded, and, for example, it is possible to obtain an advantageous effect such that delamination at a bonded portion due to a thermal cycle or an impact is suppressed.

The shape of the high-melting-point highly-conductive metal particles and the low-melting-point metal particles may be any shape, such as a spherical shape, a scale-like shape, a needle-like shape, or the like. The particle size of the high-melting-point highly-conductive metal particles and the low-melting-point metal particles is not particularly limited. For example, since an alloy reaction and dispersion proceed at a lower temperature when the particle size is smaller, the size and shape of the particles are appropriately selected in consideration of the process design and an effect of thermal hysteresis on battery characteristics.

The resin used for thermosetting conductor paste may be any resin that can function as a binder, and an appropriate resin is selected in accordance with printability, applicability, and a manufacturing process to be used. The resin used for thermosetting conductor paste includes, for example, a thermosetting resin. Examples of thermosetting resin include the following: (i) an amino resin such as urea resin, melamine resin, or guanamine resin; (ii) an epoxy resin such as bisphenol-A epoxy resin, bisphenol-B epoxy resin, phenol novolac epoxy resin, or cycloaliphatic epoxy resin; (iii) an oxetane resin; (iv) a phenol resin such as resol phenol resin or novolac phenol resin; and (v) a silicone-modified organic resin such as silicone epoxy resin or silicone polyester resin. As the resin, only one of these materials may be used, or two or more of these materials may be used in combination.

### OTHER EMBODIMENTS

Heretofore, a battery according to the present disclosure has been described based on embodiments. However, the present disclosure is not limited to these embodiments. Within the gist of the present disclosure, the scope of the present disclosure includes various modifications of the embodiments that a person having an ordinary skill in the art can conceive and other embodiments constructed by combining some of the elements of the embodiments.

Various modifications, replacements, additions, and omissions can be made on the embodiments described above within the scope of the claims or the equivalents thereof.

A battery according to the present disclosure is applicable to a secondary battery such as an all-solid-state lithium-ion battery that is used for various electronic appliances, automobiles, and the like.

What is claimed is:

1. A battery comprising:
a plurality of unit cells each including
a pair of electrode layers whose polarities differ from each other, and
a solid electrolyte layer that is positioned between the pair of electrode layers; and
a plurality of current collectors,
wherein the battery has a structure such that the plurality of unit cells and the plurality of current collectors are laminated,
wherein the plurality of current collectors include a first current collector that is positioned between the plurality of unit cells and a second current collector that is positioned at a surface portion in a laminating direction of the structure such that the plurality of unit cells and the plurality of current collectors are laminated,
wherein an end portion of the first current collector is thicker than a central portion of the first current collector, and
wherein at least a part of the first current collector is thicker than the second current collector.

2. The battery according to claim 1, further comprising:
a first covering that is continuous with the end portion of the first current collector, that extends from the end portion along a side surface of a first unit cell, among the plurality of unit cells, adjacent to the first current collector, and that covers a part of the side surface of the first unit cell,
wherein the first covering and the first current collector are integrally formed.

3. The battery according to claim 2, further comprising:
a second covering that is continuous with an end portion of the second current collector, that extends from the end portion along a side surface of a second unit cell, among the plurality of unit cells, adjacent to the second current collector, and that covers a part of the side surface of the second unit cell,
wherein the second covering and the second current collector are integrally formed, and
wherein a length of the first covering in an extension direction is larger than a length of the second covering in an extension direction.

4. The battery according to claim 2,
wherein the first covering covers a part of a side surface of an electrode layer, among the pair of electrode layers of the first unit cell, adjacent to the first current collector.

5. The battery according to claim 2,
wherein at least a part of the first covering is embedded in the side surface of the first unit cell.

6. The battery according to claim 5,
wherein the first covering does not protrude beyond the side surface of the first unit cell.

7. The battery according to claim 2,
wherein the first covering covers a part of the side surface of the first unit cell from one end to the other end of the side surface in a direction perpendicular to the laminating direction, and
wherein a length of the first covering in an extension direction is larger in both end portions of the first covering in the direction perpendicular to the laminating direction than in a central portion of the first covering in the direction perpendicular to the laminating direction.

8. The battery according to claim 2,
wherein the first covering covers a part of the side surface of the first unit cell from one end to the other end of the side surface in a direction perpendicular to the laminating direction, and
wherein a length of the first covering in an extension direction is larger in a central portion of the first covering in the direction perpendicular to the laminating direction than in both end portions of the first covering in the direction perpendicular to the laminating direction.

9. The battery according to claim 2,
wherein the first covering covers a corner of the first unit cell including an edge of the side surface of the first unit cell in a direction perpendicular to the laminating direction.

10. The battery according to claim 2,
wherein at least a part of the first covering has lower crystallinity than the first current collector.

11. The battery according to claim 2,
wherein a portion of the first covering adjacent to the side surface of the first unit cell has higher crystallinity than a portion of the first covering opposite from the side surface of the first unit cell.

12. The battery according to claim 2,
wherein a distal end portion of the first covering in an extension direction has lower crystallinity than a portion of the first covering continuous with the first current collector.

13. The battery according to claim 1,
wherein at least a part of the first current collector has higher crystallinity than the second current collector.

14. The battery according to claim 13, further comprising:
a first covering that is continuous with the end portion of the first current collector, that extends from the end portion along a side surface of a first unit cell, among the plurality of unit cells, adjacent to the first current collector, and that covers a part of the side surface of the first unit cell; and
a second covering that is continuous with an end portion of the second current collector, that extends from the end portion along a side surface of a second unit cell, among the plurality of unit cells, adjacent to the second current collector, and that covers a part of the side surface of the second unit cell,
wherein the first covering and the first current collector are integrally formed,
wherein the second covering and the second current collector are integrally formed, and
wherein at least a part of the first covering has higher crystallinity than the second covering.

15. The battery according to claim 1, further comprising:
at least one third covering that covers a part of a side surface of at least one unit cell among the plurality of unit cells, that is isolated on the side surface of the at least one unit cell, and that is electroconductive.

16. The battery according to claim 15,
wherein the at least one third covering includes a third covering at least a part of which is embedded in the side surface of the at least one unit cell.

17. The battery according to claim 15,
wherein the at least one third covering is a plurality of third coverings, and
wherein, among the plurality of third coverings, a third covering that is nearer to an end portion of the side surface of the at least one unit cell in a direction perpendicular to the laminating direction has a larger coverage area.

18. The battery according to claim 1,
wherein an electrode layer, among the pair of electrode layers of each of the plurality of unit cells, adjacent to the first current collector is thicker than an electrode layer, among the pair of electrode layers of each of the plurality of unit cells, adjacent to the second current collector.

19. The battery according to claim 1,
wherein the number of unit cells in the plurality of unit cells is greater than or equal to three, and
wherein a solid electrolyte layer of a unit cell, among the plurality of unit cells, adjacent to the first current collector and positioned between unit cells positioned at both ends in the laminating direction is thicker than a solid electrolyte layer of each of the unit cells, among the plurality of unit cells, positioned at both ends in the laminating direction.

20. The battery according to claim 1,
wherein the number of unit cells in the plurality of unit cells is greater than or equal to three, and
wherein a solid electrolyte layer of a unit cell, among the plurality of unit cells, adjacent to the first current collector and positioned between unit cells positioned at both ends in the laminating direction includes more pores than a solid electrolyte layer of each of the unit cells, among the plurality of unit cells, positioned at both ends in the laminating direction.
